(19) United States
(12) Patent Application Publication
(10) Pub. No.: US 2026/0294021 A1
(43) Pub. Date: Oct. 1, 2026

(54) TEXTILE CONFIGURED TO PROMOTE COOLING

(71) Applicant: NIKE, Inc., Beaverton, OR (US)

(72) Inventors: Karen A. Hawkinson, Portland, OR (US); Daniel P. Morgan, Portland, OR (US)

(21) Appl. No.: 19/630,295

(22) Filed: Mar. 26, 2026

Related U.S. Application Data
(60) Provisional application No. 63/868,940, filed on Aug. 22, 2025.
(60) Provisional application No. 63/779,052, filed on Mar. 27, 2025.

(51) Int. Cl. A41D 31/14; A41D 27/28; A41D 31/02; B32B 3/26; B32B 5/02; B32B 5/26; B32B 7/09; A41D 13/005

(52) U.S. Cl. CPC A41D 31/145; A41D 27/28; A41D 31/02; B32B 3/266; B32B 5/026; B32B 5/26; B32B 7/09; A41D 13/0053; A41D 2500/10; B32B 2250/20; B32B 2437/00

(57) ABSTRACT

The present disclosure is directed to garments formed of a knit spacer textile having both a plurality of flow-through apertures with an outer surface opening that is bigger than a corresponding inner surface opening, and a plurality of craters in the inner-facing surface of the knit spacer textile that do not extend through to the outer face so that no flow-through aperture is formed. The flow through apertures may have a funnel-type structure that facilitates air flow into an interior of the garment. The craters further reduce the amount of surface area of the inner-facing surface, which improves comfort and reduces clinging experienced by the wearer of a garment incorporating the knit spacer textile.

### CROSS-REFERENCE TO RELATED APPLICATIONS AND PRIORITY CLAIM

This non-provisional patent application claims priority to co-pending U.S. provisional patent app. no. 63/779,052, filed on Mar. 27, 2025, and titled “Textile Configured to Promote Cooling,” and co-pending U.S. provisional patent app. no. 63/868,940, filed on Aug. 22, 2025 and titled “Textile Configured to Promote Cooling.” The contents of the aforementioned applications are incorporated herein by reference in their entirety.

### BACKGROUND

Typical athletic garments may be formed of textiles having a plurality of apertures that promote air flow through the garment and help cool the wearer. However, features of typical textiles used for athletic garments including the size and/or configuration of apertures may not provide adequate cooling or airflow during intense activity while also providing adequate coverage or insulation when the wearer is at rest.

### BRIEF DESCRIPTION OF THE DRAWINGS

Examples of aspects herein are described below in detail with reference to the attached drawing figures, wherein:

FIG. 1 illustrates a first surface formed by a first knit layer of an example knit spacer textile in accordance with aspects herein;

FIG. 2 illustrates a top view of the knit spacer textile of FIG. 1 in accordance with aspects herein;

FIG. 3 illustrates a second surface formed by a second knit layer of the knit spacer textile of FIG. 1 in accordance with aspects herein;

FIG. 4 illustrates a top view of the knit spacer textile of FIG. 3 in accordance with aspects herein;

FIG. 5 illustrates a schematic cross-section view of the knit spacer textile of FIG. 1 along line 3-3 in accordance with aspects herein;

FIG. 6 illustrates a schematic cross-section view of the knit spacer textile of FIG. 2 along line 4-4 in accordance with aspects herein;

FIG. 7 illustrates a schematic cross-section view of the knit spacer textile of FIG. 2 along line 5-5 in accordance with aspects herein;

FIG. 8 illustrates an example upper-body garment formed from the textile described herein in accordance with aspects herein;

FIG. 9 illustrates an example lower-body garment formed from the textile described herein in accordance with aspects herein;

FIG. 10 illustrates an example upper-body garment formed from the textile described herein in accordance with aspects herein;

FIG. 11 illustrates an example upper-body garment formed in part from the textile described herein and in part from another textile in accordance with aspects herein;

FIG. 12 illustrates an example lower-body garment formed from the textile described herein in accordance with aspects herein;

FIG. 13 illustrates an example lower-body garment formed in part from the textile described herein and in part from another textile in accordance with aspects herein;

FIG. 14 illustrates a flow diagram of an example method of manufacturing the knit spacer textile of FIG. 1 in accordance with aspects herein;

FIG. 15 illustrates a velocity flow profile generated with computational flow dynamics simulation through an opening of a non-porous textile without third openings formed on the second knit layer, in accordance with aspects herein; and

FIG. 16 illustrates a velocity flow profile generated with computational flow dynamics simulation through an opening of a non-porous textile with third openings formed on the second knit layer, in accordance with aspects herein.

### DETAILED DESCRIPTION

A conventional approach to providing athletic garments that help cool the wearer during strenuous activity is to add perforations or apertures to the textile forming the garment to provide fluid passageways for air to circulate through the garment and against the skin of the wearer. These conventional perforations typically comprise holes having a consistent opening size or diameter as the perforation extends through the textile.

However, a tradeoff exists with these conventional apertures in that increasing the ratio of perforations per area of textile to improve these cooling effects also reduces the amount of coverage that the textile provides, which in turn reduces the amount of warm air that the garment can retain against the wearer’s skin when the wearer is not active.

The present disclosure is directed to garments formed of a knit spacer textile having both a plurality of flow-through apertures with an outer surface opening that is bigger than a corresponding inner surface opening, and a plurality of craters in the inner-facing surface of the knit spacer textile that do not extend through to the outer face (so that no flow-through aperture is formed).

This type of knit spacer textile is useful in many applications. For example, the knit spacer textile could be incorporated into an article of apparel. The article of apparel could be an upper-body garment or a lower-body garment, in some aspects. Examples of upper-body garments may include shirts, sleeves, tanks, and the like. Examples of lower-body garments may include shorts, pants, leggings, and the like. In other examples, the knit spacer textile could be incorporated into an article of footwear. The article of footwear could be a shoe upper, a shoe liner, a sock, and the like, in some aspects. In still other examples, the knit spacer textile could be incorporated into an article of headwear. The article of headwear could include a hat, a visor, and the like, in some aspects.

In aspects, the flow through apertures each have a funnel-type structure, which may create a Venturi effect that facilitates air flow into an interior of the garment. In examples where the ambient air from the environment is cooler than the wearer’s body temperature, the faster-moving air may then flow over the surface of a wearer’s body, and heat from the wearer’s body may be transferred to the relatively fast flowing air which facilitates wearer cooling by way of, for example, convective cooling, providing improved cooling over conventional perforations having a consistent opening size or diameter.

Specifically, the addition of the craters further reduce the amount of surface area of the inner-facing surface. Reducing the amount of textile that comes into contact with the skin results in improved comfort and reduced clinging experienced by the wearer of a garment incorporating the knit spacer textile. At the same time, because of the greater overall surface area coverage provided by the knit spacer textile than a garment with conventional apertures, the garment is better able to retain warmth when the wearer is not active.

As further discussed below, the addition of the craters may also increase the airflow velocity through the flow-through apertures. This increase in airflow may result in an increased flow rate through the flow-through apertures, in some aspects. This increase in airflow may result in elimination or reduction of stagnant zones of no-flow or low-flow of air adjacent the openings in the second layer of the flow-through apertures, in some aspects.

Accordingly, an array of craters on the skin facing side of an article of apparel can have an additive effect for real and perceived cooling experienced by the wearer.

In an aspect, the knit spacer textile comprises a first knit layer formed from a plurality of yarns and having a set of first openings, and a second knit layer formed from a second plurality of yarns comprising a set of second openings and a set of third openings.

Each of the second openings may be substantially axially aligned with a first opening, while the third openings each have a central axis that is laterally offset from a central axis of the first openings. The knit spacer textile thus comprises both a plurality of flow-through apertures (that extend through the entire thickness of the knit spacer textile) and a plurality of craters or depressions (e.g., recesses, cavities, etc.) that do not extend through the entire thickness of the knit spacer textile.

In an example, when the knit spacer textile is incorporated into a garment that is donned by a wearer, the second knit layer may be oriented to that the surface of the second knit layer is oriented to be skinward facing when the garment is worn. The knit spacer textile thus specifically may comprise both a plurality of flow-through apertures (that extend through the entire thickness of the knit spacer textile) and a plurality of craters or depressions (e.g., recesses, cavities, etc.) in the inner facing surface of the second knit layer (that do not extend through the entire thickness of the knit spacer textile).

Specifically, the flow-through apertures provide passageways for air to circulate into and out of the garment, and the craters reduce the surface area of the inner surface that can come into contact with a wearer’s skin. In addition, as further discussed below, the addition of the craters has been shown to increase the flow and the velocity of air that is adjacent to the second knit layer (e.g., within 2 mm of the second layer) in comparison with a second knit layer without craters. This increased air flow may result in the wearer’s perception of cooling.

In aspects, each of first layer and the second layer of the knit spacer textile comprise bands of knit fabric, with the bands extending in the machine direction. Each band may comprise a number of wales extending in a machine direction.

Adjacent bands may be discontinuously connected to each other in a periodic pattern, with the edges of adjacent bands separated from each other in between the connected portions to form the openings in the first or second knit layers. Where the openings of the first knit layer and the second knit layer are substantially axially aligned, a flow-through aperture is formed.

When an opening of the second layer is not axially aligned with a first layer aperture, e.g., laterally offset, a crater in the second surface may be formed.

When the knit spacer textile of the present disclosure is incorporated into the garment, the first knit layer forms an outer-facing including an outermost-facing surface of the garment, and the second knit layer forms an inner-facing including an innermost-facing surface of the garment. The first openings are located on the outermost-facing surface of the garment and the second openings and third openings are located on the innermost-facing surface of the garment. Because the first openings and second openings are substantially axially aligned, they each create a flow-through aperture that extends through the entire thickness of the knit spacer textile.

When the first opening exemplarily is larger than the second opening, a funnel-shaped aperture is formed. In other words, the cross-sectional area of the flow through aperture decreases from the first knit layer to the second knit layer.

Air that is moving over the outermost-facing surface of the garment may enter the flow-through apertures through the first openings in the first knit layer, and the air may speed up as it flows through the smaller-sized second openings in the second knit layer. Described differently, the size and configuration of the flow-through apertures may create a Venturi effect that facilitates air flow into an interior of the garment.

In examples where the ambient air from the environment is cooler than the wearer’s body temperature, the faster-moving air may then flow over the surface of a wearer’s body, and heat from the wearer’s body may be transferred to the relatively fast flowing air which facilitates wearer cooling by way of, for example, convective cooling. This cooling feature may be contrasted with more traditional garments that utilize perforations to try and cool a wearer. In examples with traditional garments, because the perforations comprise holes having a consistent opening size or diameter as the perforation extends through the textile, air entering the garment from the outside may not speed up as the air flows through the perforation. As such, air flow around the wearer’s body may be relatively reduced compared to the aperture configuration described herein, and, as a result, wearer cooling through convective cooling may be relatively reduced.

In aspects, computational fluid dynamics (CFD) simulations may optionally be performed to analyze airflow, heat transfer, and/or moisture transport across the textile. Such CFD analysis can inform the selection, placement, and/or sizing of flow-through apertures and craters in the textile to improve ventilation, perspiration management, and/or wearer comfort without limiting the textile or garment designs disclosed herein. For example, including craters on the second surface may improve airflow within the textile when donned by a wearer. That is, craters may reduce the regions interior to the textile where air has a zero or near zero (e.g., less than 1.0 m/s) velocity.

The flow-through apertures specifically accelerate airflow from the front of the textile toward the skin of a wearer, increasing its velocity at the skin interface. The inventors have discovered that placing a series of craters on the second layer of the textile, complementary to the flow-through apertures, enhances the duration of airflow circulation at the skin level, resulting in an increased cooling effect. These observations reinforce the advantages of the zonal placement of craters in combination with the flow-through apertures for improving wearer comfort.

With respect to the textile described herein, aspects herein further contemplate selecting yarn or fiber types to form the textile to further improve cooling features of the textile. In example aspects, the first plurality of yarns used to form the first knit layer may comprise absorbent yarns (i.e., yarns that have a relatively high moisture regain) that hold moisture.

In some aspects, the yarns may comprise natural fibers such as, for example, cotton, wool, and the like. The first plurality of yarns may include natural, semi-synthetic, synthetic or a combination thereof. In some aspects, the first plurality of yarns may be naturally hydrophilic and/or treated with a hydrophilic finish.

The second plurality of yarns used to form the second knit layer may comprise yarns that are relatively more hydrophobic (i.e., yarns that have a relatively lower moisture regain) than the first plurality of yarns. When the use of natural and/or semi-synthetic yarns is desired, a cellulose yarn such as viscose or LYOCELL® may be used. Creating a relatively hydrophobic surface next to the wearer’s skin may improve wearer comfort by minimizing the feel of wet material touching the skin surface.

In some examples, the plurality of tie yarns may be selected to facilitate the transport of moisture from the second knit layer to the first knit layer. For instance, the plurality of tie yarns may have features that facilitate moisture wicking or transport. Again, when the use of natural and/or semi-synthetic yarns is desired, the plurality of tie yarns may include, for example, wool (e.g., merino wool), alpaca, and the like.

In aspects, one or more of the first plurality of yarns, the second plurality of yarns, and the plurality of tie yarns may comprise DTY (drawn textured yarn). Using DTY may provide for better air circulation and/or moisture transport away from the skin. In aspects, one or more of the first plurality of yarns, the second plurality of yarns, and the plurality of tie yarns may comprise polyester, recycled polyester, mechanically recycled polyester, chemically recycled polyester, nylon, and/or cationic dyeable yarn.

The selection of yarns described above may create a hydrophilic gradient or a push/pull effect that pushes moisture from the relatively hydrophobic first knit layer to the relatively hydrophilic second knit layer via the moisture-wicking tie yarns. Once the moisture has been transported to the second knit layer, it may be stored in the second knit layer.

In examples where the ambient air is warmer than the wearer’s body temperature, air that enters the textile by way of the apertures may be cooled by way of evaporative cooling from the moisture stored in the second knit layer. For example, the heat of the ambient air may help evaporate the perspiration stored in the second knit layer (e.g., the air helps to evaporate the liquid perspiration into a vapor). When this occurs, the textile may cool as well as the air passing through the now cooler textile. The result is that the air that is passing through the textile will be at a lower temperature than the ambient air external to the textile thus helping to cool the wearer through enhanced evaporative cooling.

In other aspects, the textile may be treated in a post-knitting process to include a hydrophilic finish (or other type of finish). This could include a finish on only one side of the textile (e.g., the second knit layer side) or on both sides of the textile, in some aspects. The finish may be applied by coating the side of the textile, spraying the side of the textile, and/or dipping the textile.

The selection of yarns is also conducive in providing a textile, and a garment constructed from the textile, that has a desirable amount of drape (e.g., rigidity) when donned. The amount of drape (e.g., rigidity) in the textile, and a garment constructed from the textile, is a relevant factor for enhancing the airflow through the first and second plurality of apertures.

A number of yarn characteristics may be relevant in providing a suitable drape (e.g., rigidity), such as the yarn denier, the yarn tenacity, the yarn moisture regain percentage, and/or the yarn denier per filament, among others.

The yarns used herein (e.g., for a first knit layer, a second knit layer, tie yarns, etc.) may have a variety of deniers. For example, one or more of the first plurality of yarns, the second plurality of yarns, and the plurality of tie yarns used herein may substantially have a denier of at least 70. Some aspects may use yarns having a denier in the range of 70-160. One aspect may include one or more of the first plurality of yarns, the second plurality of yarns, and the plurality of tie yarns substantially having a denier in the range from 80D to 120D.

Similarly, the yarns used herein (that is, one or more of the first plurality yarns, the second plurality of yarns, and the plurality of tie yarns) may have a variety of tenacities. For example, the yarns used herein may substantially have a tenacity of 4 grams/denier. In another example, the yarns may substantially have a tenacity in the range of about 3.6 to about 4.8 grams/denier. In still another example, the yarns may substantially have a tenacity in the range of about 3.0 to about 5.0 grams/denier.

Likewise, the yarns used herein may have a variety of moisture regain percentages. For example, the yarns may have a moisture regain of about 10%. Some aspects may use yarns having a moisture regain in the range of about 9% to about 13%. One aspect may use a yarn having a moisture regain of 9.9%.

Further, the yarns used herein may have a variety of denier per filament. Generally, a higher denier per filament results in a stiffer (e.g., more rigid yarn). As discussed below, stiffness (e.g., rigidity) of the yarns used herein can affect how much a textile drapes when donned by a wearer. If the textile is too stiff, it may not be comfortable to wear. If the textile is not stiff enough, it may drape too much (i.e. cling to a wearer too closely) which also may not be comfortable to wear. Balancing the need for stiffness and comfort has resulted in determining a particularly useful range of denier per filament yarns.

For example, the yarns may substantially have a denier per filament in the range of 0.5 to 2.5 and provide the stiffness desired for the textile and garments disclosed herein. Some aspects that require increased stiffness may use yarns substantially having a denier per filament in the range of 1.5 to 2.5. In some aspects, the yarns may have a denier per filament of about 2.08 (e.g., 75D/36F).

Other aspects having less stiffness may use yarns substantially having a denier per filament in a range from 0.75 to 1.4. In some aspects, the yarns may substantially have a denier per filament of about 1.04 (e.g., 75D/72F).

Still other aspects having even less stiffness may use yarns substantially having a denier per filament of less than 0.75.

Stiffness of the textile may be measured using the circular bend procedure set forth in ASTM D4032-2008, which computes an average force for the textile in units of kilograms force (e.g., kgf).

Apparel textiles may have a wide range of stiffnesses. For example, some apparel textiles substantially have a stiffness in the range of 0.02-0.60 kgf. A textile that is too stiff will not fit the form of the wearer and may be uncomfortable. In addition, the moisture produced by perspiration may not be effectively transported to the outer knit layer if the textile is too stiff and not occasionally in contact with a wearer’s body. On the other hand, a textile that is not stiff enough may be too drapey (i.e., it may cling to the wearer or be too form fitting). If a textile is not stiff enough, the air flow between the wearer and the inner layer of the textile may be restricted. In either case, being too stiff or not stiff enough can result in decreased cooling to the wearer.

The textiles used herein may substantially have a stiffness with an average force of 0.101 kgf. In another example, the textiles used herein may have an average force in the range of about 0.09 kgf to about 0.11 kgf. In yet another example, the textiles used herein may have an average force in the range of about 0.07 kgf to about 0.13 kgf. In another example, the textiles used herein may have an average force in the range of about 0.05 kgf to about 0.3 kgf. Maintaining stiffness within this range enhances breathability and promotes improved airflow into/out of a space enclosed by the textile.

For example, the textile is less likely to cling to a wearer’s body, even when wet, thereby allowing ambient air to circulate and supporting increased airflow velocity across the skin.

In some aspects, the stiffness range described herein may also facilitate a pumping effect during wearer motion, in that the textile intermittently contacts and separates from the wearer’s skin without clinging for extended periods. Such intermittent contact may promote transfer of perspiration from the skin-facing side of the garment to the textile and/or to moisture-transporting yarns, while the increased air flow velocity in the interface region between the textile and the skin enhances evaporation of perspiration from the skin and from the textile. In this manner, the pumping effect may improve evaporative cooling and overall thermal comfort during athletic activity.

As used herein, the term “apparel item,” “garment,” or “athletic apparel item or garment,” means a garment configured to be worn by a wearer. In example aspects, the garment may be worn while the wearer engages in athletic activities. The garment may be in the form of a lower-body garment, that in some aspects may be form-fitting, such as a legging, tight, capri, short, and the like; an upper-body garment, that in some aspects may be form-fitting, such as a shirt or pullover; a support garment such as a sport bra or sport tank, and the like.

As used herein, the term “outer-facing surface” when referring to the garment means the surface facing away from the body of a wearer and toward the external environment. As used herein, the term “inner-facing surface” when referring to the garment means the surface facing inwardly or toward the body of the wearer.

The term “outermost-facing surface,” as used herein, means the surface that is located farthest away from the body of the wearer with respect to other layers or components of the garment, and the term “innermost-facing surface” as used herein means the surface that is located closest to the body of the wearer with respect to other layers or components of the garment.

The term “knit spacer textile,” as used herein is meant to encompass both warp knit and weft knit spacer textiles as is known in the art of textiles. Spacer textiles are generally formed by utilizing at least one tie yarn to interconnect first and second knit layers of the textile.

More specifically, each of the first layer and the second layer may be knit separately, and the tie yarn(s) is used to connect the first knit layer and the second knit layer. For instance, the tie yarns may have “loop” portions that extend into each of the first knit layer and the second knit layer where the loop portions are interlooped with yarns in the first knit layer and the second knit layer to connect the two layers.

Because each of the first knit layer and the second knit layer may be knit separately, each of the first knit layer and the second knit layer may be knit with different yarn types and/or different knit constructions although the same yarn types and same knit constructions may be used in each of the first knit layer and the second knit layer.

In aspects, one or more of the first knit layer and the second knit layer may be warp knit. Warp knit textiles may provide better dimensional stability, better run resistance, and/or faster production speeds.

In other aspects, one or more of the layers may be weft knit. Weft knit textiles may provide greater elasticity, softness and/or design flexibility, and may be preferable for articles where greater stretch is desirable.

Within a given knit layer, a particular yarn may extend throughout at least a portion of that knit layer.

To differentiate a knit spacer textile from a double-knit textile, in a double-knit textile, there is a transfer of a yarn from the face layer to the back layer and vice versa. In a knit spacer textile, there is not a transfer of yarns from the first knit layer to the second knit layer. Stated differently, yarns forming the first knit layer are separate and distinct from yarns forming the second knit layer, and the first and second knit layers are generally only connected by way of the tie yarns.

The term “moisture regain” as used herein is the amount of moisture that a material (e.g., a fiber or yarn) is able to reabsorb or has reabsorbed after it has been dried and is expressed as a weight/weight percentage (w/w%) of water in a fiber versus the fiber’s dry weight.

As used herein, the term “moisture-wicking” refers to the ability of fibers or a yarn formed from fibers to move moisture through capillary action. The capillary action typically moves moisture between fibers in a yarn.

The moisture-wicking features may be imparted by characteristics of the fibers itself. For example, merino wool fibers typically have a hydrophobic wax on the outer surface of the fiber that helps to repel moisture and forces the moisture to move between the fibers by capillary action.

In another example, the fibers may have an irregular shape (e.g., a trilobal cross-section shape, crimped fibers, and the like) that creates spaces between bundled fibers through which moisture is transported by capillary action.

The term “opening” as used herein is an intentional opening formed in a textile layer, either during the formation of the textile layer (e.g., an opening designed into the knitting pattern) or in a separate processing step (e.g., an opening formed by cutting, stamping, melting or burning, etc.). The term “opening” is not intended to encompass the gaps formed within or between inter-looped stitches in a warp knit textile or a weft knit textile.

The term “opening area” as used herein is the area of the shape formed by the perimeter of an opening. When the opening is an ellipsis/oval, the opening area is πab, where a is the radius along the semi-major axis and b is the radius along the semi-minor axis. The term “axially aligned” as used herein refers to the determined centers of, for example, a first opening and a second opening being along the same line in space. Described differently, the centers of the openings are co-linear.

The term “flow-through aperture” as used herein is a path through openings in the first knit layer and the second knit layer of the knit spacer textile in which air can travel without obstruction from the first knit layer, the second knit layer, or the plurality of tie yarns. Stated differently, an opening in the first layer must at least partially overlap an opening in the second layer, so that a line extending perpendicularly through the thickness of the knit spacer textile will not touch either the first layer or the second layer.

Although the openings in a first layer are described as being substantially axially aligned with a corresponding opening in a second layer in some aspects herein, in other aspects the first openings and the second openings may not be axially aligned, but may still at least partially overlap with each other so that a flow-through aperture is formed through the knit spacer textile.

Unless otherwise noted, all measurements provided herein are measured at standard ambient temperature and pressure (25 degrees Celsius or 298.15 K and 1 bar) with the knit spacer textile in an unworn resting state (not subject to any applied tensile or compressive forces) on a flat surface.

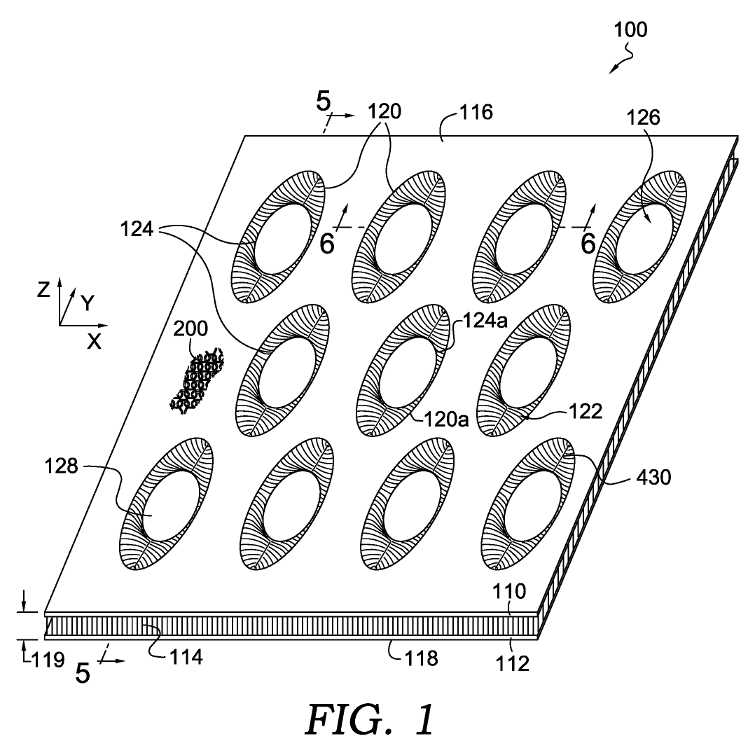

FIG. 1 depicts an example knit spacer textile 100. The knit spacer textile 100 includes a first knit layer 110 extending in an x, y plane and a second knit layer 112 extending in an x, y plane, where the second knit layer 112 substantially is parallel to and offset or spaced apart from the first knit layer 110 by a plurality of tie yarns 114 that are interlooped with the first knit layer 110 and the second knit layer 112. The first knit layer 110 forms a first surface 116 and the second knit layer 112 forms a second surface 118.

An overall thickness 119 of the knit spacer textile is measured from the first surface 116 to the second surface 118.

The thickness 119 may affect how much rigidity the knit spacer textile 100 has. Said another way, the thickness 119 of the knit spacer textile 100 may determine how much the knit spacer textile 100 drapes when the textile is donned by a wearer. For example, if the knit spacer textile 100 is too thin, it may drape too much which may lead to insufficient airflow in the space between the knit spacer textile 100 and the wearer.

In some aspects, a knit spacer textile 100 substantially having a thickness between 1.0 mm and 2.5 mm provides a useful amount of rigidity. In other aspects, the knit spacer textile 100 substantially may have a thickness 119 between 1.5mm and 2.0 mm.

In another aspect, the knit spacer textile 100 may substantially have a thickness 119 of about 1.75 mm. In aspects, the knit spacer textile 100 may substantially have a stiffness (as measured in accordance with ASTM D4032-2008) of between 0.07 and 0.13 kgf, or about 0.1 kgf.

The knit spacer textile 100 further includes openings in the first surface 116 and the second surface 118. For example, the first knit layer 110 forms a first surface 116 that includes a set of first openings 120 that extend through a thickness of the first knit layer 110.

Each first opening, such as first opening 120a, may be generally oval in shape with a first opening area 122. In other aspects, the shape of the first openings can be circular, oblong, ovular, elliptical, rectangular regular or irregular.

The first opening area 122 may be approximately the same (e.g., within ±1 to 4 mm² of each other) for each opening in the set of first opening 120. In other aspects, the first opening area 122 may vary for one or more openings in the set of first openings 120.

The first opening area 122 may be from about 100 mm² to about 300 mm², or from about 150 mm² to about 250 mm², or about 190 mm² to about 220mm².

As used herein, the term “about” means within ±5% of an indicated value.

In aspects, each opening in the set of first openings 120 may be spaced apart from an adjacent aperture by about 1 mm to about 3 mm, or about 2 mm.

The second knit layer 112 forms a second surface 118 that includes a set of second openings 124 that extend through a thickness of the second knit layer 112.

Each second opening, such as second opening 124a may be generally oval in shape with a second opening area 126. In other aspects, the shape of the second openings 124 can be circular, oblong, ovular, elliptical, rectangular, regular or irregular.

The second opening area 126 may be approximately the same (e.g., within ±1 to 4 mm² of each other) for each opening in the set of second openings 124. In other aspects, the second opening area 126 may vary for one or more openings in the set of second openings 124.

The second opening area 126 may be from about 15 mm² to about 100 mm², or from about 20 mm² to about 50 mm², or about 23 mm² to about 28 mm².

The second opening area 126, in example aspects, may be different from the first opening area 122 of the set of first openings 120. In example aspects, the second opening area 126 is smaller than the first opening area 122.

For example, the first opening area 122 may be at least about 1.01 to about 20 times greater, or about 3 to 12.5 times greater, or about 6 to 11 times greater than the second opening area 126.

In aspects, each opening in the set of second openings 124 may be from about 3 mm to about 8 mm from an adjacent opening, or from about 4 mm to about 7 mm from an adjacent opening.

Each opening in the set of second openings 124 may substantially be axially aligned with a corresponding opening in the set of first openings 120 such that a through passage is formed through the thickness 119 of the knit spacer textile 100 to form a flow-through aperture 128.

Because the second opening area 126 may be smaller than the first opening area 122, the through passage narrows as it extends from the first knit layer 110 through the second knit layer 112.

In aspects, this configuration of apertures together with the tie yarns 114 may form a funnel-like structure. As described further below, the funnel-type structure may cause air that is flowing through a flow-through aperture 128 to speed up as it moves from the first knit layer 110 to the second knit layer 112.

In the example of FIG. 1 (and as further described below), the center of each first opening 120 is axially aligned with a center of the corresponding second opening 124 in the z-direction.

Because the second opening perimeter may be smaller in all directions than the corresponding first opening perimeter, the second opening may be fully encircled by the perimeter of the first opening.

In other aspects, the centers of the first openings and the second openings may not be axially aligned, but the second opening perimeter may still be fully enclosed by the first opening perimeter, or the second opening perimeter may partially overlap with the first opening perimeter, when viewed from above the first knit layer 110.

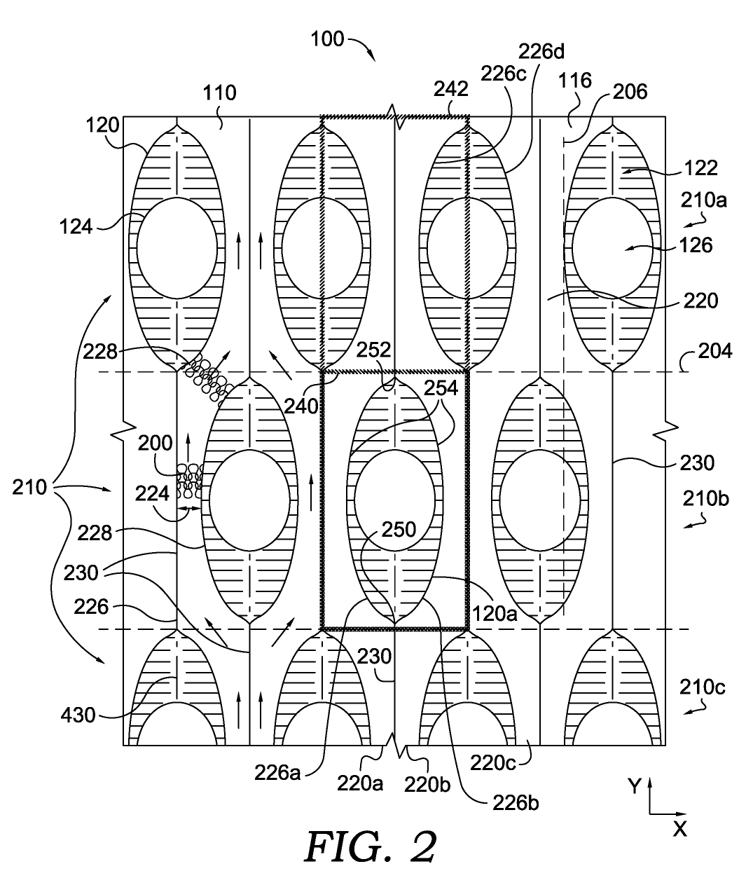

FIG. 2 depicts a top view of the first knit layer 110 of the knit spacer textile 100. A first plurality of yarns 200 forming the first knit layer 110 are depicted on the first surface 116. When incorporated into a garment, the first surface 116 would form an outer-facing surface and, in some aspects, an outermost-facing surface of the garment.

While FIG. 2 depicts the plurality of yarns 200 in a weft knit configuration, the plurality of yarns 200 may also be warp knit.

In the example shown in FIG. 2, the set of first openings 120 is shown as generally ovoid in shape although other shapes are contemplated herein (e.g., circular, elliptical, oblong, rectangular, regular, irregular, etc.).

The set of second openings 124 on the second knit layer 112 is also visible in FIG. 2 as well as the plurality of tie yarns 114 visible through first openings 120.

In the example shown in FIG. 2, the set of second openings 124 is also shown as generally ovoid in shape although other shapes are contemplated herein (e.g., circular, elliptical, oblong, rectangular, regular, irregular, etc.).

In an aspect, the set of first openings 120 are arranged in rows 210 along the x- or cross-direction of the knit spacer textile 100, with the first openings 120 in each row 210 being offset in the cross-direction from the first openings 120 in adjacent rows 210 and substantially aligned with the first openings in the next row 210 over.

For example, in the knit spacer textile 100 shown in FIG. 2, the first openings 120 in row 210a are equally offset from the first openings 120 in row 210band/or substantially aligned with the first openings 120 in row 210c.

In an aspect, the ends of the first openings 120 in adjacent rows 210 do not overlap each other. Stated differently, as seen in FIG. 2 the first openings do not intersect a line 204 between the rows 210.

In the example of FIG. 2, an overlap exists between the edges of adjacent first openings in adjacent rows. Stated differently, a tangent line 206 extending from an edge of a first opening 120 in row 210a will intersect an edge of an adjacent first opening 120 in row 210b.

In other aspects, the first openings in each row may be spaced so that the edges of first openings in adjacent rows do not overlap in the x-/cross-direction.

In the example knit spacer textile 100 of FIG. 2, the first knit layer 110 may comprise a plurality of bands 220 of knit textile with courses generally extending in a cross- or y-direction and wales generally extending in a machine- or x-direction.

Each band 220 may have a width 224, which may be measured in linear dimensions (e.g., inches or mm) and/or by the number of wales between its band edges 226. In aspects, each band 220 may have a width of between 3 to 7 wales, or between 4 to 6 wales, or 5 wales.

In aspects, each band 220 may have the same number of wales or the number of wales may be different. In some aspects, the number of wales for a band may be consistent through the length of the band. In other aspects, the number of wales across a band may change across its length.

The edges of adjacent bands may be discontinuously connected to each other along the length of the knit spacer textile 100 in the machine-direction.

For example, in FIG. 2 a first band 220a with a first band edge 226a is adjacent to a second band 220b with a second band edge 226b adjacent the first band edge 226a.

The second band 220b also has a third band edge 226c opposite the second band edge 226b. The first band edge 226aof the first band 220ais discontinuously connected to the second band edge 226b of the second band 220b along a plurality of connecting portions 230.

Likewise, the third band edge 226c of the second band 220b is discontinuously connected to a fourth band edge 226d of a third band 220c on the side of the second band 220b opposite the first band 220a. The first openings 120 may be formed between the connecting portions 230.

In aspects, each of the first openings 120 are formed where the edges of adjacent bands are disconnected from each other along the perimeter edges of the first opening 120 between an inferior end 250 and a superior end 252. The bands 220 on either side of each first opening will each have a first opening curvature 254 between the inferior end 250 and the superior end 252.

In aspects, the band edges 226 forming the connecting portions 230 are interlooped or otherwise connected with each other during the knitting process that forms the bands 220. In other aspects, the connecting portions 230 may be connected after the bands 220 are knit.

In aspects, the connection portions comprise a connecting yarn that interloops with the wales at the band edges 226 of adjacent bands 220.

In aspects, when the first knit layer is warp knitted, the connecting yarn is a yarn that is shogged between the wales at the edges of adjacent bands 220. One of skill in the art will appreciate how different shogging motions (e.g., overlapping, underlapping, etc.) can be used to impart particular characteristics to the connecting portion 230.

While the orientation of the courses and wales in each band 220 are generally along the y- or machine- direction, in aspects, the orientation of the wales may also be angled to be in alignment with an orientation of the band 220 (see, e.g., the orientation of the wales depicted by the arrows in FIG. 2) along that portion of the first knit layer 110.

In other aspects, the bands 220 are knit so that the wales maintain the same general orientation throughout the length of the band 220.

The courses may also be oriented an angle to the cross direction (see, e.g., courses 228), or they may stay generally aligned in the x- or cross-machine direction.

One of skill in the art will also appreciate that the post-processing of the second knit layer 112 may further alter the orientation of the wales and courses of the second knit layer 112.

In the example knit spacer textile of FIGS. 1 and 2, a periodic tiling may be defined for the patterning of the flow-through apertures 128 (and thus the corresponding first openings 120 and the second openings 124 of the knit spacer textile 100.

A first period tiling, for example, may be defined by a first tile 240, which is rectangular in shape and encompasses the portions of the first band 220a and the second band 220b that define first opening 120a.

One of skill in the art will appreciate that the pattern in the first tile 240 is repeated along all of the rows 210 in the knit spacer textile 100, with the pattern being offset in adjacent rows.

One of skill in the art will appreciate that other tiles can be drawn around portions of the knit spacer textile 100 that can create a periodic tiling in one or more directions. For example, a second tile 242 can be drawn that encompasses first band 220a and second band 220b across rows 210a and 210b. This second tile 242 may be repeated in both the x- and the y-direction of the knit spacer textile 100. Moreover, it may be seen that a tile of the same size and shape as second tile 242 can be drawn across any section of the knit spacer textile 100 (that is, with borders that do not align with a particular edge) and still define a repeating pattern, and that the ratio of the surface areas of the first openings and the second openings will remain the same.

In some examples, the first plurality of yarns 200 may be selected to readily absorb moisture. Stated differently, the first plurality of yarns 200 may be selected to have a relatively high moisture regain such as a moisture regain of about 5% or more, 6% or more, 7% or more, 8% or more, 9% or more, or 10% or more.

When the use of natural fibers/yarns is desired, the first plurality of yarns 200 may comprise, for example, cotton, silk, wool, flax, and the like. When synthetic fibers/yarns are desired, the first plurality of yarns 200 may comprise, for example, nylon 6 and/or nylon 66.

In some examples, a phase-change material such as a hydrogel or other hygroscopic materials may be added to the first knit layer 110 to further enhance the absorbency characteristics of the first knit layer 110.

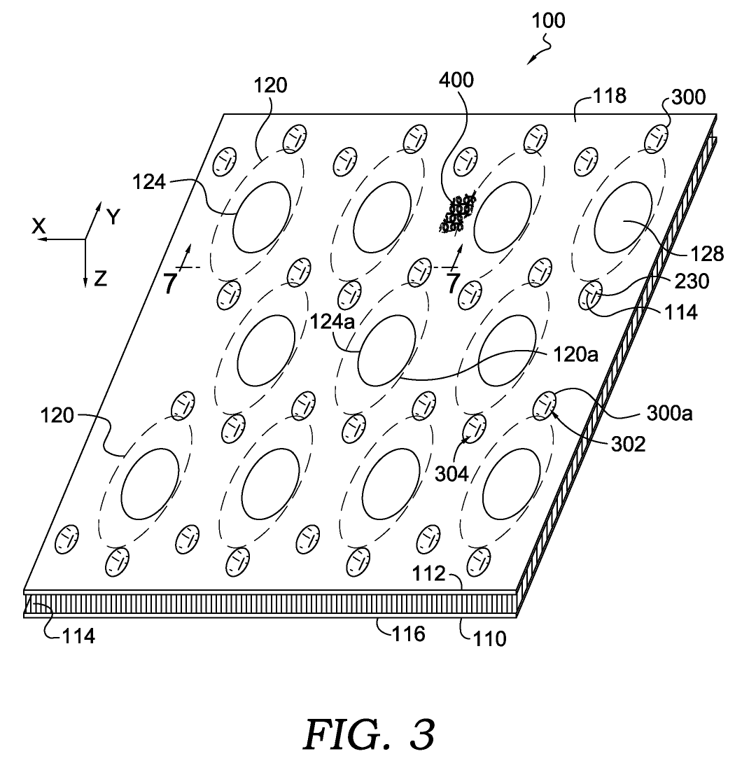

FIG. 3 depicts a view of the second surface 118 of the knit spacer textile 100 formed by the second knit layer 112. When incorporated into a garment, the second surface 118 is positioned adjacent a skin surface of a wearer and/or forms an inner-facing surface, and in some aspects, an innermost-facing surface of the garment.

In the example shown in FIG. 3, the set of second openings 124 is shown as generally ovoid in shape although other shapes are contemplated herein. Moreover, while the first openings 120 and the second openings 124 in the knit spacer textile 100 are both ovoid in shape, aspects herein contemplate that the shape of the first openings 120 and the second openings 124 may be different. For example, the set of first openings 120 may be circular in shape and the set of second openings 124 may be ovoid in shape, or vice versa.

The number of openings depicted in FIG. 3, the size of the apertures, the arrangement of the set of second openings 124, and/or the spacing between adjacent apertures is illustrative.

The second knit layer 112, in addition to the set of second openings 124 exemplarily also includes a set of third openings 300 in the second surface 118 that particularly extend through the thickness of the second knit layer 112.

Each third opening, such as third opening 300a has a third opening area 302.

The third opening area 302 may be approximately the same (e.g., within ±1 to 4 mm² of each other) for each opening in the set of third openings 300. In other aspects, the third opening area 302 may vary for one or more openings in the set of third openings 300.

The third opening area 302 may be from about 5 mm² to about 50 mm², or from about 10 mm² to about 20 mm², or from about 14 mm² to about 17 mm².

The third opening area 302, in example aspects, may be different from the first opening area 122 of the set of first openings 120 and the second opening area 126 of the set of second openings 124. In example aspects, the third opening area 302 is smaller than the first opening area 122 and the second opening area 126.

In aspects, each third opening 300 may be from about 5 mm to about 10 mm from the next adjacent third opening 300, or from about 3mm to about 5mm from the next adjacent third opening 300.

As further described below, each of the third openings 300, together with the portion of the first knit layer 110 aligned with the third opening 300 and the plurality of tie yarns 114 adjacent to a perimeter of each third opening, define a crater 304 in the knit spacer textile 100 that extends into the thickness 119 or interior of the knit spacer textile 100 but does not extend through the thickness of the first knit layer 110.

In aspects, the crater is a recess substantially in the form of an elliptical wedge, with the perimeter of the third opening 300 forming the base of the wedge, the plurality of tie yarns 114 defining the sides of the wedge that converge along the part of connecting portion 230 of the first knit layer 110 that is visible through the third opening 300. In other aspects, depending on the shape of the third opening 300 and the angle and orientation of the tie yarns 114, the crater 304 may substantially have a variety of shapes (e.g., dome, frustrum, rectangular prism, regular, irregular, etc.).

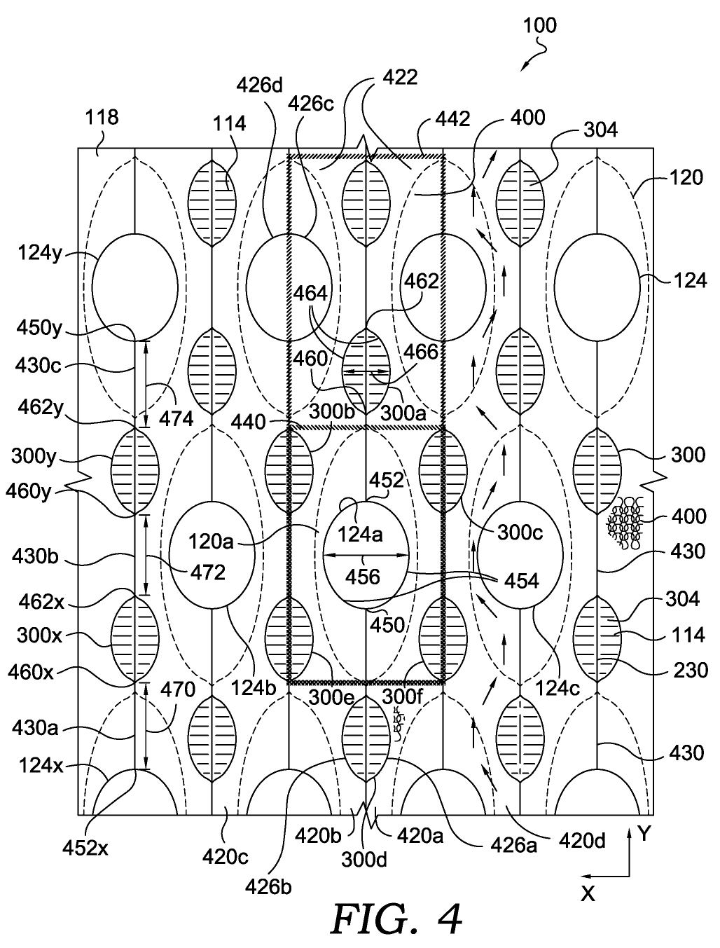

The second knit layer 112 in example aspects, is formed from a second plurality of yarns 400. While FIG. 4 depicts the plurality of yarns 400 forming the second knit layer 112 in a weft knit configuration, the plurality of yarns 200 forming the second knit layer 112 may also be warp knit.

In aspects, the same yarn used to form the first knit layer 110 may also be used to form the second knit layer 112.

In other aspects, a different yarn may be used to form the second knit layer. An example of a semi-synthetic yarn that may be used for the second plurality of yarns 400 is a cellulose yarn such as viscose or LYOCELL®. In one example, the cellulose yarn may comprise a continuously extruded wetspun cellulose yarn. Using a continuously extruded cellulose yarn such as LYOCELL® versus a staple spun cellulose yarn imparts a smooth surface to the yarn. In turn, the smooth surface provides the second surface 118 with a cooler feel or touch compared to staple spun yarns in which the fiber ends may stick out from the surface and provide a “rougher” feel to the second surface 118.

For example, in example aspects, the second layer 112 may have a QMAX of about 0.25 W/ cm² (QMAX measures the instantaneous heat transfer when the surface of a textile is contacted by a sensor). In other examples, the second layer 112 may have a QMAX of about 0.14 W/ cm² to 0.235 W/ cm². In still other examples, the second knit layer 112 may have a QMAX of about 0.10 W/ cm² to 0.30 W/cm².

Additionally, the smoothness may provide a low friction surface which improves the handfeel of the textile. Moreover, using a continuously extruded cellulose yarn versus a staple spun yarn may improve manufacturing efficiencies. For instance, the continuously extruded yarn may be better able to withstand the tension imparted to the yarns during the knitting process thus facilitating the beaming of the yarns and the warp or weft knitting of the yarns.

In one example, the second plurality of yarns 400 may have a tenacity of about 4 grams/denier. By contrast, staple spun yarns may break under high tension and may shed more than continuously extruded yarns which decreases manufacturing efficiency.

In examples, cellulose yarns such as viscose or LYOCELL® may be selected because they have a relatively higher moisture regain than, for example, polyester and/or nylon yarns. This may be desirable because the second knit layer 112 may hold some perspiration from the wearer which may help to further cool the air that is entering the flow-through apertures 128 as described further below.

In one example, the continuously extruded cellulose yarn may be combined with a yarn having a relatively lower moisture regain to reduce the overall moisture regain of the second plurality of yarns 400. For example, a LYOCELL® yarn may be twisted with a polyester or recycled polyester yarn to reduce the overall moisture regain of the twisted yarn.

When the use of synthetic fibers/yarns is desired, the second plurality of yarns 400 (or fibers) may comprise for example, polyester including recycled polyester, spandex, acrylic, modacrylic, and the like. The use of thermally conductive yarns/fibers is also contemplated herein to help transport heat away from the wearer’s skin surface and to impart a “cool” feel to the second surface 118. The cool feel may also be imparted by way of a finish (e.g., a “cool-touch” finish) applied to the second surface 118.

The surfaces of the knit spacer textile 100 may have an “openness” that is a ratio of the surface area of the openings in that surface of any of the flow-through apertures in the knit spacer textile to the total surface area of that surface on a per unit area basis, expressed as a percentage. For example, with respect to the knit spacer textile 100 of FIGS. 1-3, the openness of the second surface 118 would be the ratio of the surface area of any second opening areas 126 within a unit area of the second surface 118, but would not include any of the surface area of the third opening areas 302 of any craters 304, because the craters 304 do not form flow-through apertures in the knit spacer textile 100.

It is also to be appreciated that for a knit spacer textile 100 where the through passages have first opening areas 122 that are larger than the corresponding second opening areas 126, that the openness of the first surface 116 is greater than the openness of the second surface 118.

It is also to be appreciated that the openness is affected by the number of openings per unit area as well as the area of each opening.

In an example where the centers of each second opening 124 are spaced 10 mm apart in a grid fashion, the knit spacer textile will have about 10,000 openings/m².

In aspects, the openness of the second surface 118 of the knit spacer textile 100 is between about 5% and 30%, or between about 10% and about 25%, or between about 15% to 20%. In an aspect, the openness of the second surface 118 is about between 16% and 18%. In other aspects, the openness of the second surface 118 is more than 20%.

In aspects, a knit spacer textile in accordance with the present disclosure may substantially have a dry air permeability (i.e., how easily dry air can flow through a solid or porous material when driven by a pressure difference) of greater than 300 cfm, as measured by ASTM D737-2018.

In an aspect, the dry air permeability of the knit spacer textile 100 (pre-washing) is between 380 and 600 cfm, or between 420 and 560 cfm. It has generally been observed that the dry air permeability of the knit spacer textile may decrease after several washings; in aspects, the decrease may be between about 10 to 100 cfm.

FIG. 4 depicts a top view of the second surface 118 of the knit spacer textile 100 of FIG. 3. A second plurality of yarns 400 forming the second knit layer 112 are depicted on the second surface 118. The second knit layer 112 may comprise a plurality of bands 420 of knit textile with courses generally extending in a cross- or y-direction and wales generally extending in a machine- or x-direction.

Similar to the bands 220 of the first knit layer 110, each band 420 may have a width measured in the number of wales between band edges 426. In aspects, each band 420 may have a width of between 3 to 7 wales, or between 4 to 6 wales, or 5 wales.

In aspects, each band 420 may have the same number of wales or the number of wales may be different. In some aspects, the number of wales for a band may be consistent through the length of the band. In other aspects, the number of wales across a band may change across its length. In aspects, the number of wales in each of the bands in the second knit layer 112 may be the same number of wales in each of the bands 220 of the first knit layer 110.

The band edges of adjacent bands may be discontinuously connected to each other along the length of the knit spacer textile 100 in the machine-direction.

For example, in FIG. 4 a first band 420a with a first band edge 426a is adjacent to a second band 420b with a second band edge 426b adjacent the first band edge 426a.

The second band 420b also may have a third band edge 426copposite the second band edge 426b.

The first band edge 426a of the first band 420a may be discontinuously connected to the second band edge 426b of the second band 420b along a plurality of connecting portions 430. Likewise, the third band edge 426cof the second band 420b may be discontinuously connected to a fourth band edge 426d of a third band 420c on the side of the second band 420b opposite the first band 420a.

In some aspects, similar to the first openings 120 of the first knit layer 110, the second openings 124 and third openings 300 may be formed between the connecting portions 430.

In aspects, the band edges 426 forming the connecting portions 430 are interlooped or otherwise connected with each other during the knitting process that forms the bands 420. In other aspects, the connecting portions 430 may be connected after the bands 420 are knit.

In aspects, the connection portions 430 comprise a connecting yarn that interloops with the wales at the band edges 426 of adjacent bands 420.

In aspects, when the first knit layer is warp knitted, the connecting yarn is a yarn that is shogged between the wales at the edges of adjacent bands 420. One of skill in the art will appreciate how different shogging motions (e.g., overlapping, underlapping, etc.) can be used to impart particular characteristics to the connecting portion 430.

Also similar to the bands 220 of the first layer, the orientation of the courses and wales in each band 420 may generally stay aligned in the x- (cross) and y- (machine-) directions respectively, or they may be angled depending upon the portion of the band (see, e.g., the orientation of the wales depicted by the arrows in FIG. 4 along band 420d).

As seen in the band 420d, the orientation of the wales of a band may change their orientation back and forth relative to the perimeter edges of the second openings 124 and the third openings 300 along the band edges 426. In an aspect, the band may undergo five or inflections between second openings 124 that are axially aligned with each other in the machine-direction. As used herein, an inflection is a point between the angling of the wales relative to the machine direction. Stated differently, an inflection is a relative apex of the lateral positioning of a band in the cross-direction.

Similar to the first openings 120 and the bands 220 of the first knit layer 110, each of the second openings 124 may be formed where the edges of adjacent bands 420 are disconnected from each other along the perimeter edges of the second opening 124 between an inferior end 450 and a superior end 452.

The bands 420 on either side of each second opening may each have a second opening curvature 454 between the inferior end 450and the superior end 452.

The third openings 300 may also be formed where the edges of adjacent bands 420 are disconnected from each other along the perimeter edges of the second opening 124 between an inferior end 460 and a superior end 462, with the bands 420 on either side of each third opening 300 having a third opening curvature 464 between the inferior end 460 and the superior end 462.

In aspects, the second opening curvature 454 is greater than the third opening curvature 464.

In aspects, a first distance 456 between the first band 420a and the second band 420b at a second opening mid-point (which may the minor axis of the second opening 124) is different than a second distance 466 between the first band 420a and the second band 420b at a first crater mid-point (which may be the minor axis of the third opening 300).

In the example of FIG. 4, a first crater 300x and a second crater 300y are substantially axially aligned in a cross-direction with a first second opening 124x and a second second opening 124y. A superior end 452x of a second opening 124x may be a first distance 470 (corresponding to connecting portion 430a) from an inferior end 460x of the crater 300x, the superior end 462x of the first crater 300x may be a second distance 472 (corresponding to connecting portion 430b) from an inferior end 460y of the second crater 300y, and a superior end 462y of the second crater 300y may be a third distance 474 (corresponding to connecting portion 430c) from the inferior end 450y of the second second opening 124y.

In an aspect, the first distance 470 is different than the second distance 472.

In an aspect, the first distance 470 is less than the second distance.

In an aspect, the third distance is different than the second distance.

In an aspect, the third distance is less than the second distance.

In an aspect, the third distance is substantially equal to the first distance.

As seen with respect to the first second opening 124x, the second second opening 124y, the first crater 300x and the second crater 300y, the band 420d

Because there are not corresponding openings in first knit layer 110 that overlap with the third openings 300, portions of the first knit layer 110, some of the plurality of tie yarns 114, and the connecting portions 230 in the first knit layer 110 can be seen in the view of FIG. 4.

The craters 304 (and their corresponding third openings 300) may be arranged together with the second openings 124 on the second surface 118 in a repeating pattern.

In the example of FIG. 4, the second openings 124 and third openings 300 may be arranged in a series of rows, with two third openings 300 being positioned in between each pair of adjacent second openings 124. It can also be seen that in the example of FIG. 4 each third opening 300 may be superior to and axially aligned with a second opening in a machine direction. In other aspects, different configurations and ratios of second openings 124 to third openings 300 can be present.

As with the first openings 120 on the first surface 116, the second openings 124 and third openings 300 may be configured on the second surface 118 in a periodic tiling pattern that may correspond with a periodic tiling pattern of the first surface 116.

For example, a third tile 440 is shown in FIG. 4 corresponding to the size and positioning of the first tile 240 shown in FIG. 2. Third tile 440 thus encompasses one second opening 124 and half of each of the four third openings 300 adjacent to the second opening 124. Third tile 440 may also repeat along the rows of the second knit layer 112, with the pattern being offset in adjacent rows.

Similarly, a fourth tile 442 corresponding to the second tile 242 is also shown in FIG. 4 and repeats in both the x- and y-directions.

While the example knit spacer textile 100 illustrated in FIG. 4 shows the third openings 300 (and thus the craters 304) in a 2:1 ratio with respect to the second openings 124, in other aspects the craters 304 may vary in number, size, and positioning relative to the second openings 124. Stated differently, in some examples there may a third opening 300 and a single second opening 124 per tile, and in other examples there may be three or more third openings 300 per second opening 124 on a per-tile basis.

In another way to describe the non-limiting pattern illustrated in FIG. 4, a first crater 300a, a second crater 300b, and a third crater 300c are superior to the second opening 120a, and a fourth crater 300d, a fifth crater 300e, and a sixth crater 300f are inferior to a first second opening 120a. First second opening 120ais also in a row 210 between a second second opening 120b and a third second opening 120c. Stated differently, the second second opening 120band the third second opening 120c are each adjacent and offset in opposite directions from the first second opening 120a along a cross-direction axis.

In an aspect, the first second opening 124a, the second second opening 124b and the third second opening 124care substantially axially aligned in a cross-direction.

In an aspect, the first crater 300a and the fourth crater 300d are substantially axially aligned with the first second opening 124a in the machine-direction.

In an aspect, the second crater 300b and the fifth crater 300e are between the first second opening 124a and the second second opening 124b in the cross-direction.

In an aspect, the third crater 300c and the sixth crater 300f are between the first second opening 124a and the third second opening 124c in the cross-direction.

The knit spacer textile 100 may be incorporated into a garment so that when the garment is donned by a wearer the second surface 118 of the second knit layer 112 is positioned directly adjacent to the body surface of the wearer and/or forms an inner-facing surface, and in some aspects, an innermost-facing surface of the garment.

The first knit layer 110 is spaced apart from the second knit layer 112 by the plurality of tie yarns 114 such that the first knit layer 110 is not in contact with the body surface of the wearer.

When the wearer’s body surface begins to perspire, the perspiration can come into contact with the second knit layer 112 and the second knit layer 112 helps to “pull” the perspiration off of the wearer’s body, thereby improving wearer comfort.

Because the second plurality of yarns 400 that form the second knit layer 112 may be relatively hydrophobic, it pushes the perspiration toward the moisture-wicking tie yarns 114. In examples where a cellulose yarn, such as a continuously extruded cellulose yarn is used, some perspiration may be retained in the second knit layer 112.

As described below, this may enhance the cooling effect that occurs when air from the environment enters the flow-through apertures 128.

In aspects where the second knit layer 112 is a non-absorbent hydrophobic layer such that it does not absorb the perspiration (e.g., where the moisture uptake is either prevented or significantly inhibited), the moisture-wicking tie yarns 114 that are interlooped with the second knit layer 112 may support transporting the perspiration to the first knit layer 110.

The moisture-wicking tie yarns 114 may support transporting the perspiration to the first knit layer 110. Because the first knit layer 110 is relatively more hydrophilic than the second knit layer 112, it helps to pull the perspiration from the second knit layer 112 and from the tie yarns 114.

Once the perspiration reaches the first knit layer 110, it is absorbed by the first plurality of yarns 200. The absorbed perspiration may spread laterally along the first knit layer 110, and/or retained perspiration in the first knit layer 110 may help to cool the wearer by way of evaporative cooling. This may be especially beneficial when the ambient air is hotter than the wearer’s body temperature.

In this example, air that enters the knit spacer textile 100 by way of, for example, the flow-through apertures 128, may transfer heat to the perspiration causing the perspiration to change from a liquid to a vapor. The transfer of heat helps to cool the air. The evaporation of the perspiration helps to cool the knit spacer textile 100.

The result is that the air that is passing through the knit spacer textile 100 may be at a lower temperature than the ambient air external to the knit spacer textile 100 thus helping to cool the wearer through enhanced evaporative cooling.

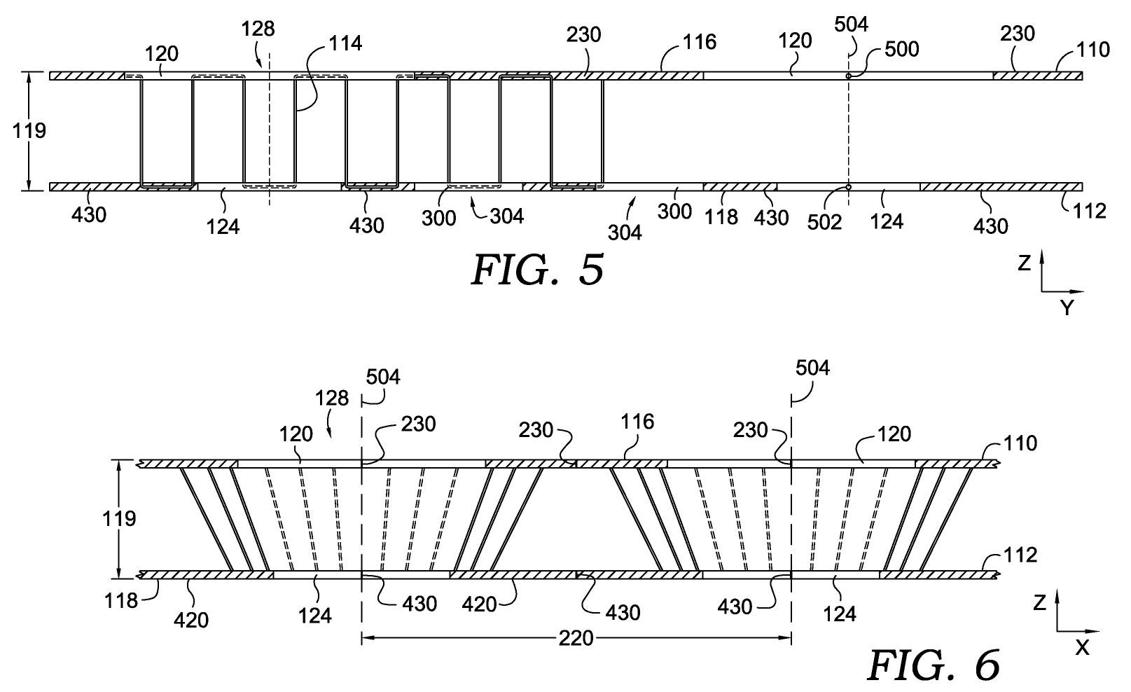

Turning to FIGS. 5-7, cross section views across different cut-lines in FIGS. 1-2 and 3-4 are shown to help illustrate the positioning of the first knit layer 110, the second knit layer 112 and their respective openings (e.g., first openings 120, second openings 124 and third openings 300) relative to each other and to the plurality of tie yarns 114.

As noted above, the set of first openings 120 may be substantially axially aligned with the set of second openings 124 and not aligned with the set of third openings 300.

As seen in FIGS. 5 and 6, the first openings 120 may be substantially axially aligned with second openings 124; that is, the center 500 of first opening 120 substantially is aligned with a center 502 of the corresponding second opening 124 along axial alignment line 504.

In other aspects, the centers of the first openings 120 and the second openings 124 are not axially-aligned with each other but the perimeter of the second opening 124 may still be circumscribed by the perimeter of the first opening 120. In yet other aspects, the perimeter of a first opening may partially overlap with a perimeter of the corresponding second opening 124.

In FIG. 5, a single tie yarn 114 to better illustrate how a tie yarn 114 may be interlooped with the yarns forming the first knit layer 110 and the second knit layer 112 respectively (shown in dashed lines to indicate these portions are generally hidden from view).

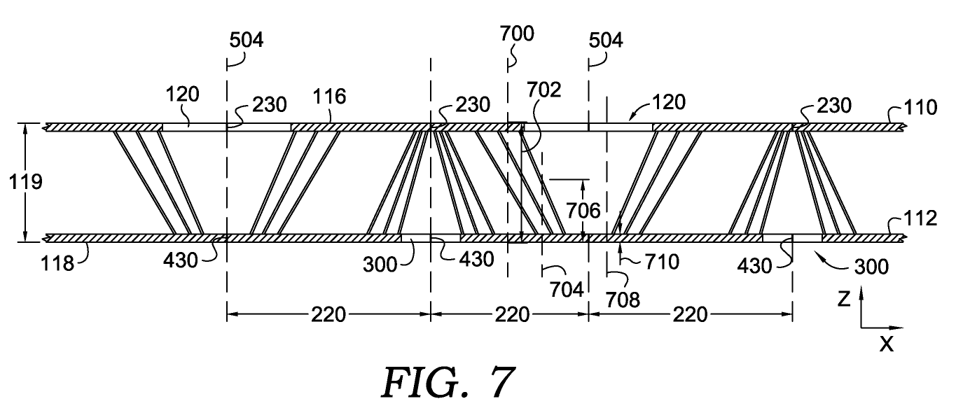

As used throughout this disclosure, the term “loop” or “loop portion” when referring to tie yarns refers to the portion of the tie yarn that extends into the first knit layer 110 and the second knit layer 112 and is interlooped with yarns in the first knit layer 110 and the second knit layer 112. However, it is contemplated herein (as shown in FIGS. 6-7) that multiple tie yarns 114 may be used to interconnect the first knit layer 110 and the second knit layer 112.

Moreover, in FIG. 5 the representative tie yarn 114 is shown as substantially extending perpendicularly (from the viewing angle of FIG. 5) to either or both of the first knit layer 110 and the second knit layer 112. However, as shown in FIGS. 6 and 7, at least some of the tie yarns 114 may extend at an angle less than ninety degrees from either or both of the first knit layer 110 and the second knit layer 112 (referred to herein as extending at an angle to such knit layers).

When at least some of the tie yarns 114 adjacent to a second opening 124 extend at an angle to either or both of the first knit layer 110 and the second knit layer 112 (such as shown in FIG. 6), the flow-through apertures 128 substantially are provided with a funnel-type structure. Said another way, the flow-through apertures 128 may present a beveled edge.

In examples, this beveled edge may have a constant angle relative to one or both of the first knit layer 110 and the second knit layer 112. In further examples, this beveled edge may have a variable angle around its perimeter relative to one or both of the first knit layer 110 and the second knit layer 112. That is, the tie yarns at one position around the perimeter extend at an angle nearer ninety degrees than do tie yarns at another position around the perimeter.

For example, in the context of a warp knitted knit spacer textile having a machine direction and a cross direction, the beveled edge presented on the cross direction ends may be less sloped than the beveled edge presented on the machine direction ends.

This structure specifically occurs when tie yarns 114 extend from a position adjacent an aperture in the first knit layer 110 to a position adjacent an aperture in the second knit layer 112. When viewed from the first knit layer 110 side, these tie yarns 114 are visible through the first opening 120 (but would be obstructed from view through the second opening 124 when viewed from the second knit layer 112 side).

Although described as a funnel-type structure, this description is not limited to a set of circular openings having a constant diameter. As described below, the first openings 120 and/or the second openings 124 may have a variety of shapes (e.g., circular, oblong, ovular, elliptical, rectangular, rectangular, regular, irregular, etc.), which need not match one another. In such cases, the funnel-type structure may not have a constant diameter, merely a reducing cross-sectional area from the first knit layer 110 to the second knit layer 112.

In example aspects, the plurality of tie yarns 114 may be selected to provide moisture wicking capabilities. In aspects, one or more of the first plurality of yarns, the second plurality of yarns, and the plurality of tie yarns may comprise Drawn Textured Yarn (DTY). Using DTY may provide for better air circulation and moisture transport away from the skin. Again, when the use of natural and/or semi-synthetic yarns is desired, the plurality of tie yarns may include, for example, wool (e.g., merino wool), alpaca, and the like.

Turning to FIG. 7, the thickness of the knit-spacer textile may vary depending upon where it is measured. For example, along line 700, a thickness 702 is measured from the first surface 116 to the second surface 118.

Along line 704, the thickness 706 is measured from the second surface 118 to the intersection of line 704 with the tie yarn 114. Along line 708, the thickness 710 is measured to be the thickness of the second knit layer 112. Similarly, lines taken along different positions along a portion the knit spacer textile 100 where a crater 304 is present will also have different thicknesses.

It is to be appreciated that the basis weight of the knit spacer textile 100 along these different sections may be different from each other. Designing a garment with a knit spacer textile 100 having varying thicknesses and/or basis weights provides additional flexibility and tailoring of the knit spacer textile’s properties to achieve desired characteristics.

For example, in FIG. 3 the basis weight of the knit spacer textile 100 may be greater at portions not corresponding to the flow-through apertures 128 or the craters 304 (the “maximum basis weight”).

As discussed herein, the flow-through apertures 128 may have a beveled surface (e.g., comprised of tie yarns) that extends from the perimeter of the first opening 120 to the perimeter of the of the second opening 124. In this beveled surface region, the basis weight of the knit spacer textile 100 is less than the maximum basis weight. That is, portions of the beveled surface region nearer the first opening 120 will have a greater basis weight than portions of the beveled surface region nearer the second opening 124, but in both cases they will each be less than the maximum basis weight.

Also as discussed herein, the craters 304 may similarly have a variable depth from the perimeter of the crater to a central location within the thickness of the knit spacer textile 100. In aspects, the central location may be an apex of the crater that is positioned deepest within the thickness of the knit spacer textile. Stated differently, the apex is the point or region in the crater 304 that is furthest away from the second surface 118 in the z-direction.

Thus, across the variable depth of the craters 304 the basis weight of the knit space textile 100 is less than the maximum basis weight. That is, portions of the craters 304 nearer third opening 300a will have a greater basis weight than portions nearer the centers of the craters 304, but again in both cases they will each be less than the maximum basis weight.

Because of the gradient in basis weight across the beveled surface region and the gradient in basis weight across the variable depth craters 304, there will be some portions of the beveled surface region that have a greater basis weight than some portions of the craters 304. Likewise, there will be some portions of the craters 304 that have a greater basis weight than some portions of the beveled surface region.

At the flow-through apertures 128 within the perimeter of the second openings 124 (i.e., where no textile is present), the knit spacer textile 100 has a zero basis weight.

It is contemplated that outside of this zero region, however, the minimum basis weight for the knit spacer textile corresponds with the thinner of the first knit layer 110 and the second knit layer 112 (which in some aspects may be equal).

In some aspects, there are portions of the craters 304 that extend into the knit spacer textile 100 all the way to the first knit layer 110. Thus, the basis weight at these portions depends on the thickness of the first knit layer 110.

In some aspects, there are portions of the beveled surface region that extend into the knit spacer textile 100 all the way to the second knit layer 112. Thus, the basis weight at these portions depends on the thickness of the second knit layer 112.

The depiction of the knit spacer textile 100 as shown in FIGS. 5-7 is illustrative only. For example, it is contemplated herein that the first knit layer 110 and the second knit layer 112 may be positioned closer to or further from each other than shown.

As well, the orientation of the tie yarns 114 may be different than that shown. For example, some or all of the tie yarns 114 may be oriented generally perpendicular to the x, y plane of the first knit layer 110 and the second knit layer 112 or some or all of the tie yarns 114 may be oriented at angles less than 90 degrees.

Any and all aspects, and any variation thereof, are contemplated as being within the scope herein. For example, a first plurality of tie yarns at or near a periphery of the set of first openings 120 of the first knit layer 110 and connecting the second knit layer 112 at or near a periphery of the corresponding set of second openings 124 of the second knit layer 112 may be oriented at a more acute angle with respect to the x, y plane compared to an orientation of a plurality of tie yarns that interconnect the first knit layers 110 and the second knit layers 112 outside of the periphery of the apertures.

The number of openings (first openings 120, second openings 124 and third openings 300) in the knit spacer textile 100, the size and arrangement of the openings, and the spacing between adjacent openings is also illustrative.

Aspects herein contemplate an irregular arrangement of openings, different spacing between openings, different sizes for the openings, and/or a different number of openings, and the like.

For example, the irregular arrangement, different spacing, different sizes, different number, or other different character of apertures may change from a first zone of the textile to a second zone of the textile.

In one aspect, the first zone may comprise an edge region of the textile (e.g., the area of the textile within three inches of the edge of the textile) and the second zone may comprise an interior region of the textile (e.g., an area of the textile more than 3 inches from the edge of the textile).

In example aspects, there is a one-to-one correspondence in number between the set of first openings 120 and the set of second openings 124 such that each opening in the set of first openings 120 is substantially axially aligned with a corresponding opening in the set of second openings 124.

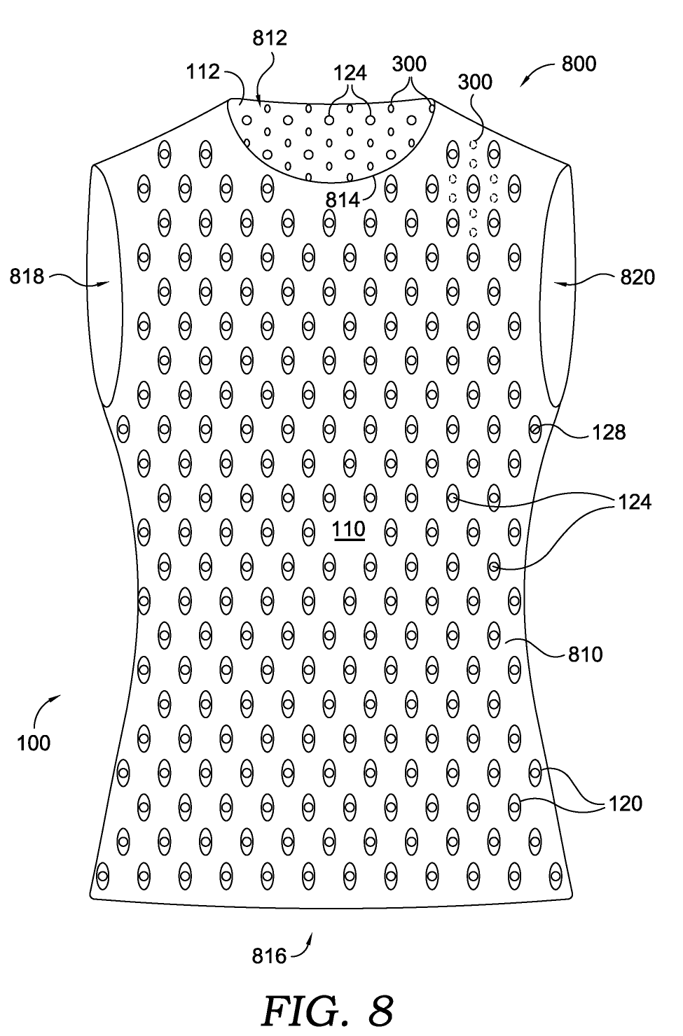

FIG. 8 illustrates an upper-body garment 800 formed in whole, or in part, from the knit spacer textile 100.

In example aspects, the first knit layer 110 is positioned to substantially face outward or externally as shown. Thus, the first knit layer 110 forms an outer-facing surface including an outermost-facing surface of the upper-body garment 800.

In example aspects, the second knit layer 112 substantially faces inwardly to form an inner-facing surface including an innermost-facing surface of the upper-body garment 800.

The upper-body garment 800 is depicted as a tank having a front torso portion 810, a back torso portion 812, a neck opening 814, a waist opening 816, a first sleeve opening 818, and/or an opposite second sleeve opening 820. Although shown as a tank, it is contemplated herein that the upper-body garment 800 may include other configurations such as, for example, a top with sleeves, a jacket, a support garment, a bra, a hoodie, and/or a half-tank, and the like. In example aspects, the upper-body garment 800 may be form-fitting, and in other example aspects, the upper-body garment 800 may be not form-fitting (e.g., loose).

The larger-sized set of first openings 120 is positioned on the outermost-facing surface of the front torso portion 810, and the smaller-sized set of second openings 124 is also visible through the set of first openings 120, each pair of first openings 120 and second openings 124 forming a flow-through aperture 128. The set of second openings 124 may be positioned on the innermost-facing surface of the upper-body garment 800.

Aspects herein contemplate that the flow-through apertures 128 may also be present on the back torso portion 812. For example, as depicted near the neck opening 814, the second knit layer 112 is visible as well as second openings 124 and third openings 300 (which form craters 304 in the second knit layer 112).

The depiction of the flow-through apertures 128 in FIG. 8 is illustrative, and aspects herein contemplate that the flow-through apertures 128 and their corresponding first openings 120 and second openings 124 may have different sizes than that shown, a different configuration than that shown, and the like. Similarly, the depiction of the third openings 300 and craters 304 is illustrative only, and each may have a different size or configuration than shown.

Although the flow-through apertures 128 and craters 304 are depicted as being present throughout the front and back torso portions 810 and 812, aspects herein contemplate that the flow-through apertures 128 and or craters 304 may be zonally located based on, for example, heat and/or sweat maps of the human body. For example, the flow-through apertures 128 and craters may be located in areas of high heat and/or sweat-producing parts of the human body (e.g., upper back, upper front).

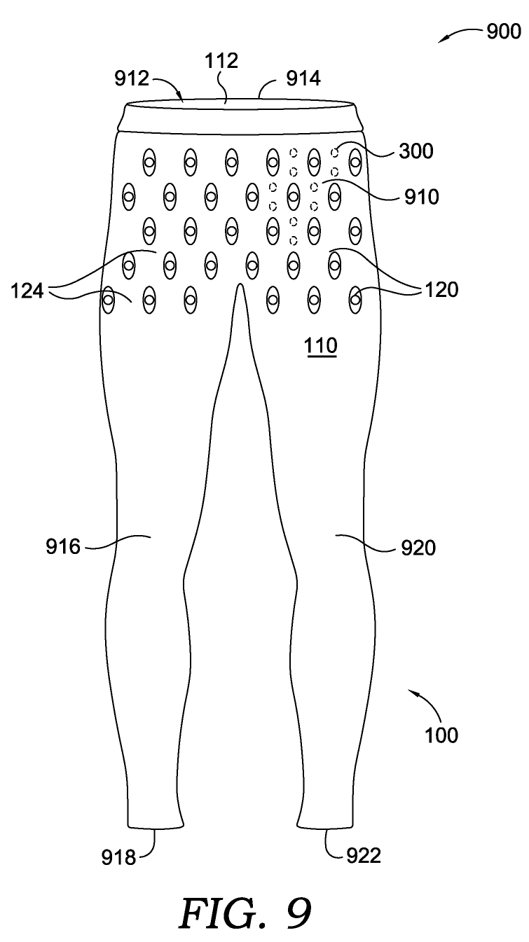

FIG. 9 illustrates a lower-body garment 900 formed in whole, or in part, from the knit spacer textile 100. In example aspects, the first knit layer 110 is positioned to substantially face outward or externally as shown. Thus, the first knit layer 110 forms an outer-facing surface including an outermost-facing surface of the lower-body garment 900.

In example aspects, the second knit layer 112 substantially faces inwardly and forms an inner-facing surface including an innermost-facing surface of the lower-body garment 1220.

The lower-body garment 900 exemplarily is depicted as a legging having a front torso portion 910, a back torso portion 912, a waist opening 914, a first leg portion 916 having a first leg opening 918, and/or a second leg portion 920 having a second leg opening 922. Although shown as a legging, it is contemplated herein that the lower-body garment 900 may include other configurations such as, for example, a three-quarter tight, a half-tight, a short, a singlet, and/or a unitard, and the like. Aspects herein contemplate that the lower-body garment 900 may be form-fitting or loose.

The larger-sized set of first openings 120, e.g., is positioned on the outermost-facing surface of the front torso portion 910, and the smaller-sized set of second openings 124 is also visible.

The set of second openings 124, e.g., is positioned on the innermost-facing surface of the lower-body garment 1220.

Representative craters 304 on the innermost-facing surface of the front torso portion 910 are also depicted in dashed lines.

Aspects herein contemplate that the flow-through apertures 128 and craters 304 may also be present on the back torso portion 912.

The depiction of the flow-through apertures 128 and craters 304 in FIG. 9 is illustrative, and aspects herein contemplate that the flow-through apertures 128 and craters 304, and their corresponding first openings 120, second openings 124 and/or third openings 300 may have different sizes than that shown, a different configuration than that shown, and the like.

The flow-through apertures 128 and craters 304 in FIG. 9 are depicted as being zonally located based on, for example, heat and/or sweat maps of the human body. Aspects herein also contemplate that the flow-through apertures 128 and craters may be present throughout the front and back torso portions 910 and 912 and the first and second leg portions 916 and 920.

In another aspect, a garment may include a first set of flow-through apertures and craters in one zone and a second set of flow-through apertures and craters in another zone. The first set of flow-through apertures and craters may have one or more properties that are different from the second set of flow-through apertures and craters.

In one example, the first set of flow-through apertures may have different sizes compared to the second set of flow-through apertures, and as such air flow properties (e.g., air flow velocity) through the first set of flow-through apertures may be different from the air flow properties through the second set of flow-through apertures.

In another example, the first set of craters may have different sizes compared to the second set of craters, and as such the amount of the inner surface of the garment relative to an area of the garment may be different.

The first set of flow-through apertures may each include a first opening and a second opening, such as the first opening 120 in the first knit layer 110 and the second opening 124 in the second knit layer 112 all in the knit spacer textile 100 as shown in FIG. 1.

Likewise, the second set of flow-through apertures may each include a first opening and a second opening. While the above example describes two zones, in some examples, the garment may comprise more than two zones, each having different flow-through apertures structures and/or crater structures.

In one example, the different zones in the garment may be integrally formed. For example, a first zone having the first set of flow-through apertures and craters and a second zone having a second set of flow-through apertures and craters may include a common yarn extending across the first and the second zones on at least a first surface of the garment.

In another example, the different zones may be formed by coupling different textiles together. For example, the first zone may be formed with a first textile having a first set of flow-through apertures and craters and the second zone may be formed with a second textile having a second set of flow-through apertures and craters.

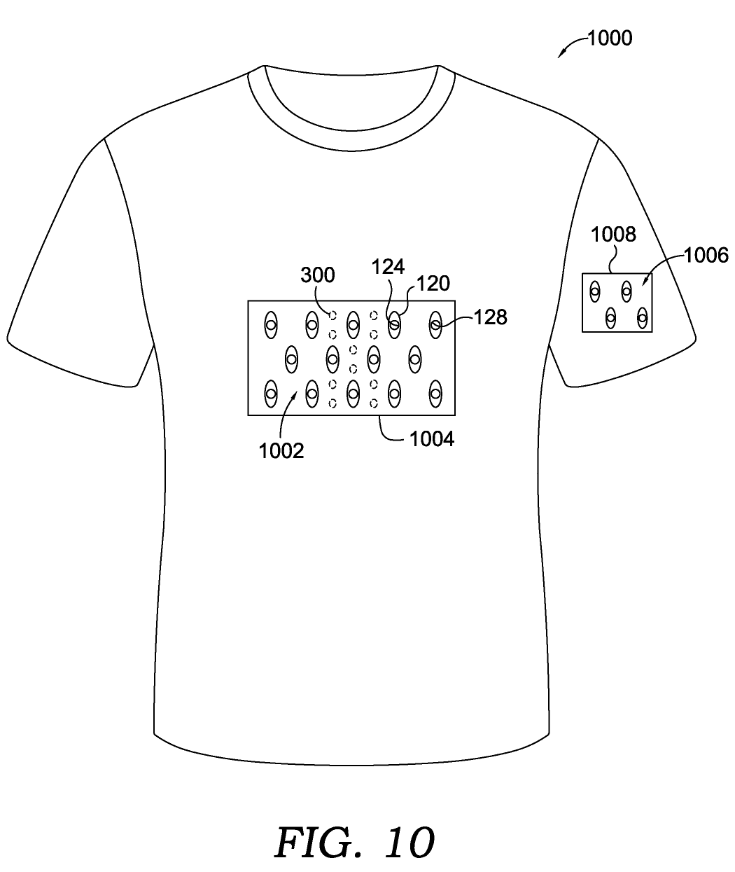

Turning to FIG. 10, an upper-body garment 1000 is depicted as a shirt. In aspects, the upper-body garment 1000 may be donned over an underlayer (e.g., a bra) that is worn for modesty, support, or other purposes. The underlayer may only be associated with a portion of the upper-body garment 1000 (e.g., a chest region, etc.). Aspects herein contemplate first and second sets of flow-through apertures (e.g., 1002 and 1006) and/or craters being zonally located based on, for example, regions of the upper-body garment 1000 associated with where an underlayer would be worn when the upper-body garment 1000 is donned.

For example, the upper-body garment 1000 may include a first set of flow-through apertures 1002 and a second set of flow-through apertures 1006. The first set of flow-through apertures 1002 may be positioned in a first zone 1004 of the upper-body garment 1000 and the second set of flow-through apertures 1006 may be positioned in a second zone 1008 of the upper-body garment 1000.

As illustrated, the first zone 1004 is located in a chest region of the upper-body garment 1000 and the second zone 1008 is located in a sleeve region of the upper-body garment 1000.

The flow-through apertures 1002 and the flow-through apertures 1006 may have the same size and configuration (e.g. pattern), or they may be different.

The arrangement and/or size of the flow-through apertures may promote localized airflow and encourage directional movement of moisture from zones of higher perspiration toward zones of lower perspiration, supporting thermal comfort and moisture management.

While not shown, each of the first zone 1004 and the second zone 1008 may also comprise craters, such as craters 304, that may be the same size or a different size, in the same or different configuration. Each of the first zone 1004 and the second zone 1008 may be comprised of a textile such as knit spacer textile 100.

Although shown as spaced apart, the first zone 1004 and the second zone 1008 may be positioned adjacent one another. Likewise, while depicted as two discrete zones of the upper-body garment 1000, in some aspects either the first zone 1004 or the second zone 1008 may comprise the entirety of the upper-body garment 1000 except for the portion comprising the other zone.

In still further aspects, the upper-body garment 1000 may include additional textiles to complete the garment outside of the first zone 1004 and the second zone 1008. In addition, the upper-body garment 1000 may include a plurality of first zones 1004 and/or a plurality of second zones 1008.

In another aspect, a garment may comprise a first textile in one zone and a second textile in another zone. The first textile may have one or more properties or structures that are different from the second textile. In one example, the first textile may comprise a knit textile, a woven textile, a non-woven textile, or a double-knit textile while the second textile may comprise the knit spacer textile 100.

While the above example describes two zones, in some examples, the garment may comprise more than two zones, each having different textiles.

In one example, the different zones in the garment may be integrally formed. For example, a first zone having the first textile and a second zone having the second textile may include a common yarn extending across the first and the second zones on at least a first surface of the garment.

In another example, the different zones may be formed by coupling different textiles together. For example, the first zone may be formed with a first textile and the second zone may be formed with a second textile.

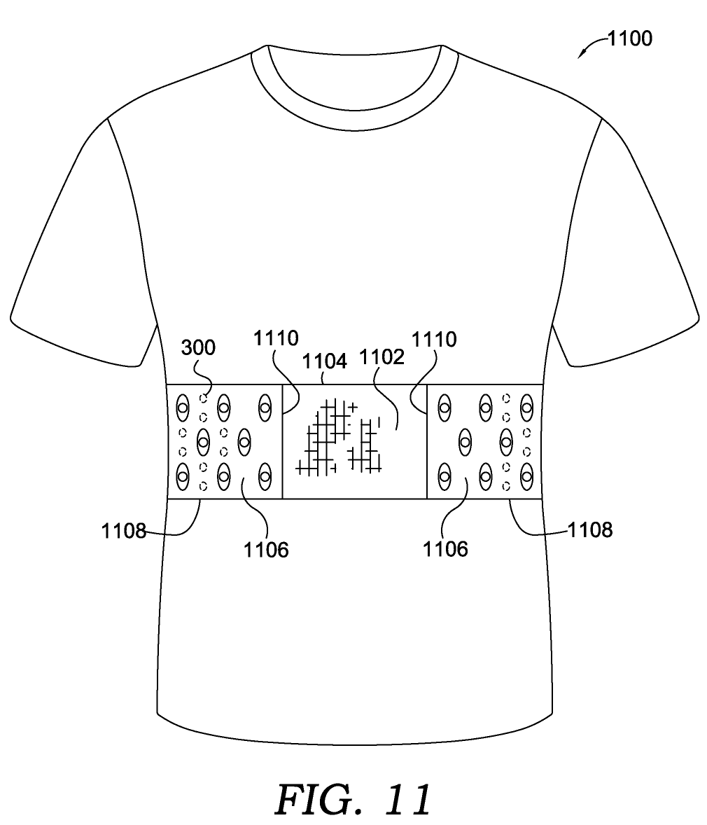

FIG. 11 illustrates an upper-body garment 1100. The upper-body garment 1100 is depicted as a shirt. In aspects, the upper-body garment 1100 may be comprised of two or more textiles. Aspects herein contemplate a first textile 1102 and a second textile 1106 being zonally located based on, for example, heat and/or sweat maps of the human body.

For example, a first textile 1102 may be present in a first zone 1104 and a second textile 1106 may be present in a second zone 1108, where the first zone 1104 is associated with a lower sweat region of the human body and/or the second zone 1108 is associated with a higher sweat region of the human body.

The first textile 1102 may comprise a textile that includes hydrophobic characteristics, such as the hydrophobic characteristics discussed above.

In aspects, the first textile 1102 may be a knit textile, a double knit textile, a non-woven textile, or a woven textile.

In aspects, the first textile 1102 may include a durable water repellant finish applied to one surface.

The hydrophobic characteristics of the first textile 1102 may encourage perspiration from a wearer to move towards a less hydrophobic portion of the upper-body garment 1100 (e.g., second zone 1108). Such zonal differentiation in textile properties and apertures can enhance moisture transport and ventilation, facilitating passive cooling and improved comfort during wear.

The first textile may also have a decorative layer or finish applied to one of its surfaces, such as by printing, silk-screening, and/or the application of a heat transfer decal or patch. In the alternative or in addition, the material of the first textile may be dyed to impart a desired visual aesthetic.

The decorative layer, finish or dye may be applied uniformly in a regular pattern, or applied to form a symbol, logo, lettering, or in an irregular pattern.

The second textile 1106 may comprise the knit spacer textile 100 described above. In aspects, the second knit layer 112 of the second textile 1106 may be less hydrophobic (or, said another way, more hydrophilic) than the first textile 1102. In this way, perspiration may be taken up more readily by the second textile 1106 than the first textile 1102.

In aspects, the upper-body garment 1100 may include one or more first zones 1104 and one or more second zones 1108. For example, the aspect depicted includes one first zone 1104 flanked by a second zone 1108 on either lateral side thereof.

In aspects, the first zone 1104 may be positioned adjacent to the second zone 1108. For example, the first textile 1102 may be joined to the second textile 1106. In aspects, the first textile 1102 is joined to the second textile 1106 at a seam 1110.

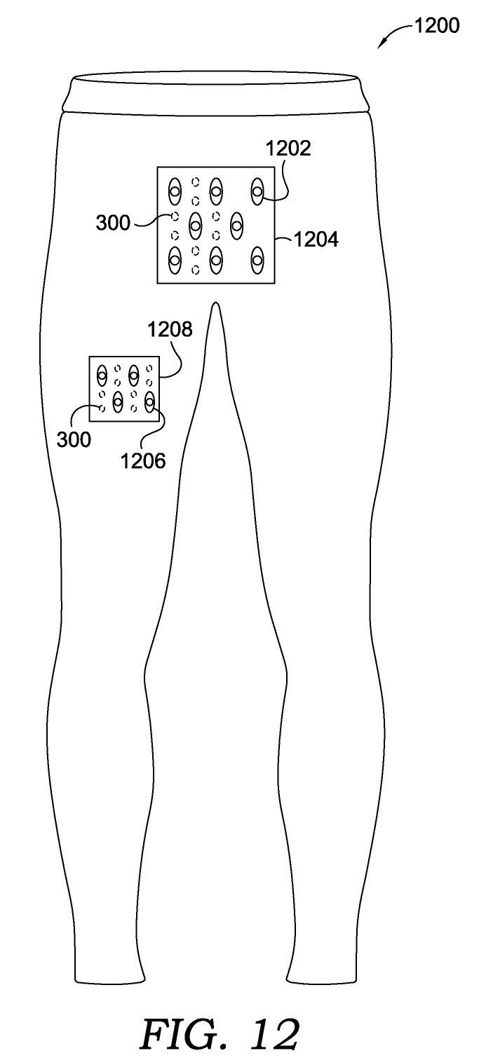

Referring to FIG. 12, a lower-body garment 1200 is shown. The lower-body garment 1200 may comprise a pant or a short. Thus, it is contemplated that the lower-body garment 1200 may include a first set of flow-through apertures 1202 and/or a second set of flow-through apertures 1206 that are zonally located based on, for example, regions of the lower-body garment 1200 where an underlayer would be worn when the lower-body garment 1200 is donned.

Thus, the first set of flow-through apertures 1202 specifically are positioned in a first zone 1224 and the second set of flow-through apertures 1206 are positioned in a second zone 1208. Otherwise, the lower-body garment 1200 is similar to the upper-body garment 1000 and each of the variations discussed in reference to the upper-body garment 1000 need not be repeated here.

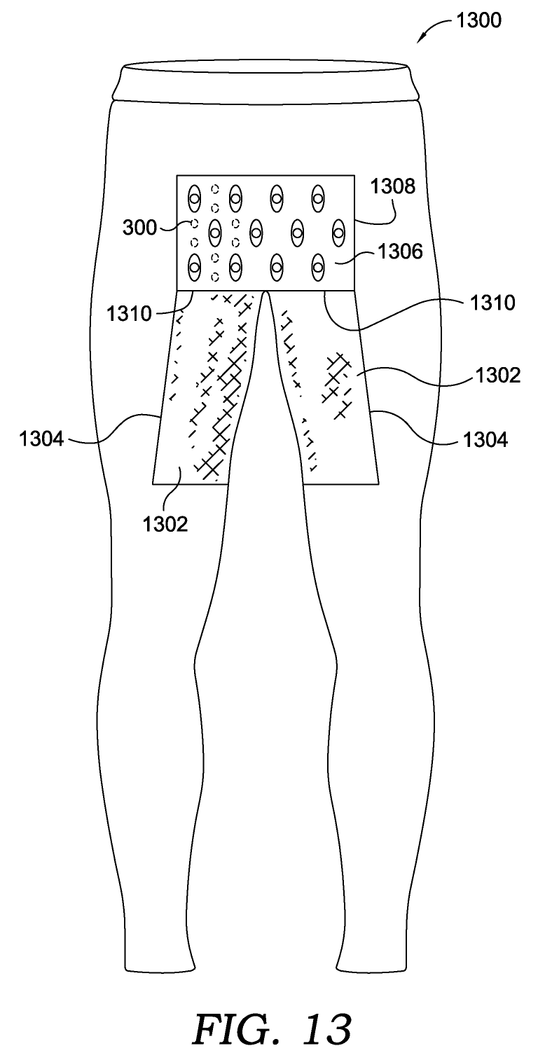

Referring to FIG. 13, a lower-body garment 1300 is shown. The lower-body garment 1300 may comprise a pant or a short. In aspects, the lower-body garment 1300 may be comprised of two or more textiles, for example a first textile 1302 and a second textile 1306.

It is contemplated that the first textile 1302 and the second textile 1306 are zonally located based on, for example, heat and/or sweat maps of the human body. Thus, the first textile 1302 may be located in a first zone 1304 and the second textile 1306 may be located in a second zone 1308.

The first zone 1304 is shown, e.g., positioned along an in-seam of the lower-body garment 1300 while a second zone 1308 is shown, e.g., positioned at a pelvic region of the lower-body garment 1300.

In aspects, the first zone 1304 is adjacent the second zone 1308 such that the first textile 1302 is joined to the second textile 1306 at a seam 1310. Otherwise, the lower-body garment 1300 is similar to the upper-body garment 1100 and each of the variations discussed in reference to the upper-body garment 1100 need not be repeated here.

The openings described throughout the specification may be formed in either of the first knit layer 110 and/or the second knit layer 112 in a variety of ways. For example, the openings may be integrally formed through knitting or they may be removed from the textile layer (e.g., cutting, punching, penetrating, laser-cutting, etc.). Additional post processing steps (such as heat-processing) may also further alter the size and shape of the openings.

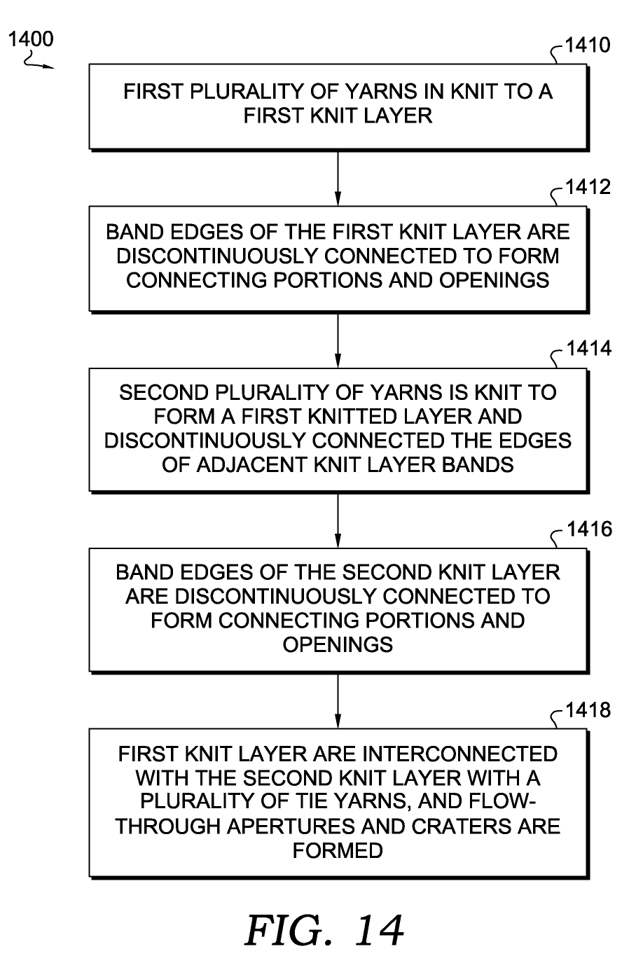

FIG. 14 depicts a flow diagram of an example method 1400 of manufacturing a knit spacer textile such as the knit spacer textile 100. At a step 1410, a first plurality of yarns, such as the first plurality of yarns 200, is knitted to form a first knit layer such as the first knit layer 110.

As a step 1412, the band edges of adjacent bands, such as bands 220 of the first knit layer are discontinuously connected. This step may occur during the knitting step 1410 or at another point in the method 1400.

At a step 1414, a second plurality of yarns, such as the second plurality of yarns 400, is knitted to form a second knit layer such as the second knit layer 112.

At a step 1416, the band edges of adjacent bands, such as bands 220 of the first knit layer are discontinuously connected. This step may occur during the knitting step 1414 or at another point in the method 1400.

At a step 1418, the first knit layer is interconnected with the second knit layer using a plurality of tie yarns such as the plurality of tie yarns 114, and flow-through apertures, such as flow-through apertures 128, and craters, such as craters 304, are formed.

The tie yarns may be selected to be moisture-wicking and may include natural, semi-synthetic, and/or synthetic yarns including recycled yarns (e.g., mechanically or chemically recycled). In example aspects, the plurality of tie yarns 114 may be selected to provide moisture wicking capabilities.

Some examples of natural fibers that are moisture wicking include wool, including merino wool, alpaca wool, and the like.

Aspects herein also contemplate using synthetic or semi-synthetic moisture-wicking fibers such as LYOCELL®, polyester including recycled polyester, nylon, spandex, viscose, and the like.

Aspects also contemplate using DTY, which may provide sufficient rigidity to the textile such that garments formed from the textile may have a beneficial amount of drape (e.g., rigidity) while also having beneficial moisture wicking to move perspiration from the second knit layer 112 to the first knit layer 110.

The method 1400 may further include one or more post knitting treatments. For example, after any of steps 1410, 1412, 1414 1416 and 1418 discussed above, the knit spacer textile (or one or more of its components such as the first knit layer or the second knit layer) may be heat processed such as heat set into a desired configuration, shape, and/or position. The heat setting may hold the first set of apertures, the second set of apertures, and/or the craters in a desired position, shape, and/or configuration.

Another example of a post knitting treatment includes, after any of steps 1410, 1412, 1414,1416 and 1418 discussed above, the knit spacer textile may be stretched into a desired configuration, shape, and/or position. Stretching may open the first set of apertures, the second set of apertures, and/or the craters to a desired size, shape, and/or position.

Another example of a post knitting treatment includes, after any of steps 1410, 1412, 1414,1416 and 1418 discussed above, the knit spacer textile having a coating at least partly applied to one or more surfaces of the first knit layer and the second knit layer of the knit spacer textile. The coating may provide increased or decreased hydrophilic or hydrophobic characteristics to the treated surface, which may promote the moisture wicking described above.

Yet another example of a post knitting treatment includes, after any of steps 1410, 1412, 1414,1416 and 1418 discussed above, the knit spacer textile may be molded (with or without the application of heat and/or pressure) to create a pattern, indentation, raised structure, and/or other surface feature on one or more surfaces of the first knit layer and the second knit layer of the knit spacer textile.

The pattern may provide aesthetic characteristics to the treated surface.

The indentation, particularly when on the inner surface of the knit spacer textile, may reduce contact between a wearer’s skin surface and the knit spacer textile resulting in reduced cling.

The raised structure, particularly when on the inner surface of the knit spacer textile, may create stand-off between the knit spacer textile and the wearer’s skin surface to promote airflow therebetween and/or to reduce cling.

Still another example of a post knitting treatment includes, after any of steps 1410, 1412, 1414,1416 and 1418 discussed above, sublimation printing on the knit spacer textile. Sublimation printing on the knit spacer textile may enhance the aesthetic quality of the textile by incorporating color or a design aspect on one or more surfaces (e.g., the outer surface) of the knit spacer textile.

Although described as separate post knitting treatments, in some aspects after any of steps 1410, 1412, 1414,1416 and 1418 discussed above two or more of the post knitting treatments may be applied to the knit spacer textile. Any combination in any order of the above described post knitting treatments is contemplated.

The method 1400 may further include forming the knit spacer textile into a garment such as the upper-body garment 800 and/or the lower-body garment 900. When incorporated into a garment, the first knit layer may form an outer- or outermost-facing surface of the garment, and the second knit layer forms an inner- or innermost-facing surface of the garment.

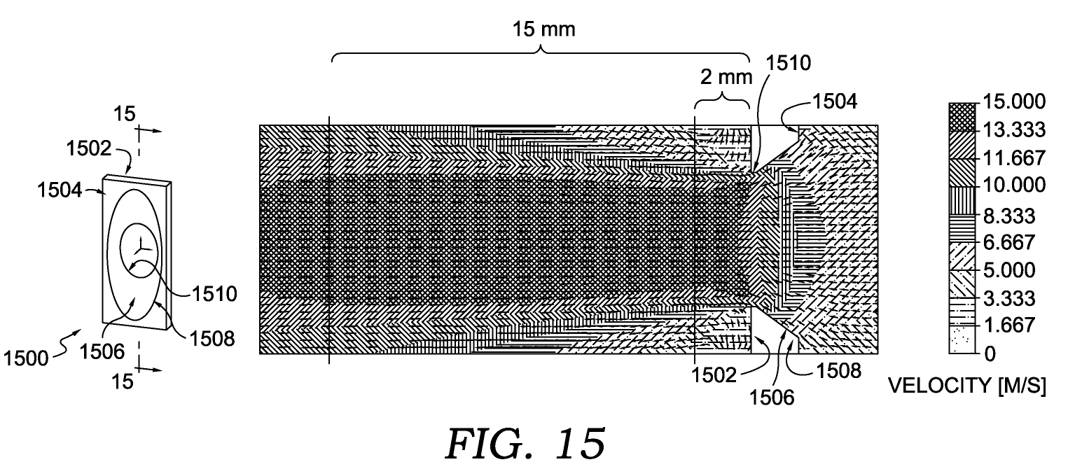

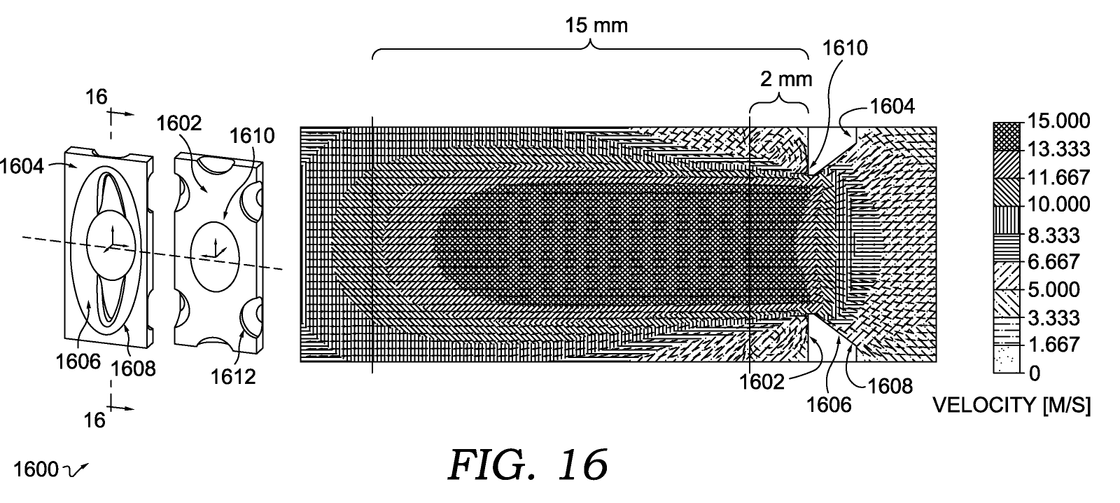

Turning now to FIGS. 15 and 16, example velocity profiles generated from computational fluid dynamics (CFD) simulations of airflow through the textile’s flow-through apertures are depicted. In FIG. 15, a non-porous textile 1500 having a first surface 1504 opposite a second surface 1502 was simulated.

The textile 1500 included a first opening 1508 in the first surface 1504 and a second opening 1510 in the second surface 1502. A beveled surface 1506 extends between the perimeter of the first opening 1508 and the perimeter of the second opening 1510.

The illustrated velocity profile depicts the cross-section of the textile 1500 at a mid-point of one flow-through opening, shown by the dashed cut line 15-15. It is noted that the cut line 15-15 is parallel to the X-axis in FIG. 15. It is further noted that the velocity profile depicted is viewed from the Y-axis. The airflow is shown as flowing through the flow-through aperture in the Z-axis direction. Notably, there are no craters present in the second surface 1502 of the textile 1500.

As depicted in FIG. 15, the velocity profile depicts pockets of very low flow (e.g. less than 1.0 m/s), or no flow, adjacent the second surface 1502 and adjacent the perimeter of the second opening 1510 for up to 2 mm behind the second surface 1502.

In FIG. 16, a non-porous textile 1600 having a first surface 1604 opposite a second surface 1602 was simulated (views of both surfaces are shown in FIG. 16).

The textile 1600 included a first opening 1608 in the first surface 1604 and a second opening 1610 in the second surface 1602. A beveled surface 1606 extends between the perimeter of the first opening 1608 and the perimeter of the second opening 1610. It is noted that the beveled surface 1606 is not uniform in order to more closely approximate a knit spacer textile where the tie yarns between layers are not perfectly uniform.

The illustrated velocity profile depicts the cross-section of the textile 1600 at a mid-point of one flow-through opening, shown by the dashed cut line 16-16. It is noted that the cut line 16-16 is parallel to the X-axis in FIG. 16. It is further noted that the velocity profile depicted is viewed from the Y-axis. The airflow is shown as flowing through the flow-through aperture in the Z-axis direction.

In contrast to the textile 1500, however, the textile 1600 includes craters 1612 in the second surface 1602. As depicted in FIG. 16, the inclusion of the craters 1612 has nearly eliminated the pockets of very low flow (e.g. less than 1.0 m/s), or no flow, adjacent the second surface 1602 and adjacent the perimeter of the second opening 1610 as compared with the velocity profile of FIG. 15.

In other words, CFD shows that including the craters 1612 in the second surface 1602 results in increased air velocity inside a garment constructed from the textile 1600, which in turn provides a cooling effect to the wearer. These results illustrate that the inclusion of craters 1612 in the second surface 1602 can improve airflow not only through the flow-through apertures but also in the surrounding regions, enhancing overall ventilation.

It will be appreciated that the CFD results shown in FIGS. 15 and 16 are illustrative examples. Variations in the size, shape, and/or placement of craters, as well as the configuration of flow-through apertures, may produce similar or enhanced airflow, heat transfer, and moisture transport effects.

Further, the illustrated aspects were generated by modelling a non-porous textile (which can occur when the textile becomes wet), but similar results may be obtained when modeling a porous textile (which may result from the spaces between knit loops when the textile is dry). Accordingly, the present disclosure is not limited to the specific CFD configurations shown, and other textile or garment designs may achieve comparable or improved ventilation and perspiration management.

Experimental evaluation of the textiles described herein demonstrated improved performance relative to conventional textiles. The textiles described herein retained less sweat during prolonged running in hot conditions. Retaining less sweat is advantageous because a garment made from the textile will have less cling, which improves the breathability and airflow of such a garment. It is also advantageous because it encourages evaporative cooling when in hot conditions, which provides cooling to the wearer.

Additional testing using thermal manikins indicated that the textiles described herein were substantially more breathable and/or exhibited lower resistance to sweat evaporation compared to conventional textiles. These results support the aspects described herein, including the placement and sizing of flow-through apertures and craters, which contribute to enhanced breathability, moisture management, and wearer comfort.

The following clauses represent example aspects of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1. An article of apparel comprising: a knit spacer textile comprising: a first knit layer formed from a first plurality of yarns, the first knit layer comprising a set of first openings; a second knit layer formed from a second plurality of yarns, the second knit layer comprising a set of second openings and a set of third openings, wherein each of the second openings at least partially overlaps with one of the first openings, and the third openings do not overlap with any of the first openings; and a plurality of tie yarns that interconnect the first knit layer and the second knit layer; wherein: the second knit layer comprises a plurality of bands with wales extending in a machine direction, the plurality of bands comprises a first band, a second band, and a third band; the first band has a first band edge that is discontinuously connected to a second band edge of the second band, and a third band edge of the second band opposite the second band edge is discontinuously connected to a fourth band edge of the third band.

Clause 2. The article of apparel of clause 1, wherein the first band, the second band and the third band each comprise at least three wales.

Clause 3. The article of apparel of any of clauses 1 to 2 wherein the first band edge and the second band edge are connected across a first set of courses at a first location, and the third band edge and the fourth band edge are connected across a second set of courses at a second location that is offset from the first set of courses in the machine direction and a cross direction.

Clause 4. The article of apparel of clause 3, wherein the wales of the second band between the first location and the second location are angled relative to the machine direction.

Clause 5. The article of apparel of clause 3, wherein the third band edge and the fourth band edge are spaced apart at a third location aligned with the first location in a cross direction perpendicular to the machine direction to form one of the second openings, and the first band edge and the second band edge are spaced apart at a fourth location aligned with the second location in the cross direction to form one of the third openings.

Clause 6. The article of apparel of any of clauses 1 to 5, wherein the first band edge and the second band edge are connected at a first plurality of second knit layer connecting locations spaced apart in the machine direction and the third band edge and the fourth band edge are connected at a second plurality of second knit layer connecting locations spaced apart in the machine direction, wherein at least some of the first plurality of second knit layer connecting locations are offset from the second plurality of second knit layer connecting locations in the machine direction and a cross direction.

Clause 7. The article of apparel of clause 6, wherein the first edge and the second edge are spaced apart at a plurality of spaced-apart second knit layer locations between the first plurality of connecting locations, each of the spaced-apart second knit layer locations defining one of the second openings or one of the third openings.

Clause 8. The article of apparel of any of clauses 1 to 7, wherein the first layer comprises a second plurality of bands of knit fabric comprising a second number of wales that are knit in the machine direction; wherein: the second plurality of bands comprises a fourth band, a fifth band, and a sixth band; the fourth band has a fifth band edge that is discontinuously connected to a sixth band edge of the fifth band that is opposite the fifth band edge, and a seventh band edge of the sixth band is discontinuously connected to an eighth band edge of the sixth band.

Clause 9. The article of apparel of clause 8, wherein the fifth band edge and the sixth band edge are connected at a first plurality of first layer connecting locations periodically spaced in the machine direction and the seventh band edge and the eighth band edge are connected at a second plurality of first layer connecting locations periodically spaced in the machine direction, where the first plurality of first layer connecting locations are at least partially offset from the second plurality of first layer connecting locations in the machine direction and a cross direction.

Clause 10. The article of apparel of clause 9, wherein the fifth band edge and the sixth band edge are spaced apart at a plurality of spaced-apart first layer locations, each of the spaced-apart first layer locations defining one of the first openings.

Clause 11. The article of apparel of any of clauses 1 to 10, wherein the first knit layer and the second knit layer are weft knit.

Clause 12. The article of apparel of any of clauses 1 to 11, wherein the first knit layer and the second knit layer are warp knit.

Clause 13. The article of apparel of any of clauses 1 to 12, wherein the second knit layer comprises at least a portion of a skin-facing layer of an article of apparel.

Clause 14. A knit spacer textile comprising: a first knit layer formed from a first plurality of yarns; a second knit layer formed from a second plurality of yarns; a plurality of tie yarns that interconnect the first knit layer and the second knit layer; a first flow-through aperture extending from a first opening in the first knit layer to a second opening in the second knit layer; and a first crater formed in the second knit layer, the first crater superior to and axially aligned with the second opening in a machine-direction; wherein: the second knit layer comprises a plurality of bands, each band comprising at least three wales extending in a machine direction, the plurality of bands comprises a first band and a second band; the first band is disconnected from the second band along a perimeter edge of the second opening from a second opening inferior end to a second opening superior end; and the first band is disconnected from the second band along a perimeter edge of the first crater from a first crater inferior end to a first crater superior end.

Clause 15. The knit spacer textile of clause 14, wherein the crater comprises a third opening in the second knit layer and a recess that extends partially into a thickness of the knit spacer textile.

Clause 16. The knit spacer textile of any of clauses 14 to 15, wherein a first distance between the first band and the second band at a second opening mid-point is different than a second distance between the first band and the second band at a first crater mid-point.

Clause 17. The knit spacer textile of any of clauses 14 to 16, comprising: a second flow-through aperture extending from a third opening in the first knit layer to a fourth opening in the second knit layer; and a second crater formed in the second knit layer; wherein: the second flow-through aperture is aligned in a machine direction with the first flow-through aperture; the second crater is aligned in a machine direction superior to the first crater; the first band is disconnected from the second band along a perimeter edge of the fourth opening from a fourth opening inferior end to a fourth opening superior end; the first band is disconnected from the second band along a perimeter edge of the second crater from a second crater inferior end to a second crater superior end; a third distance between the first band and the second band at a second crater mid-point is less than the first distance; and a fourth distance between the first band and the second band at a fourth opening mid-point is greater than the second distance and the third distance.

Clause 18. The knit spacer textile of clause 17, wherein the third distance is equal to the second distance and the fourth distance is equal to the first distance.

Clause 19. The knit spacer textile of clause 17, comprising: a first connecting portion connecting the first band and the second band between a superior end of the second opening and an inferior end of the first crater; a second connecting portion connecting the first band and the second band between a superior end of the first crater and an inferior end of the second crater; a third connecting portion connecting the first band and the second band between a superior end of the second crater and an inferior end of the fourth opening; wherein: the first connection portion, the second connection portion, and the third connection portion comprise one or more connection yarns, each of the one or more connection yarns comprising one of the second plurality of yarns.

Clause 20. The knit spacer textile of clause 19, wherein the second knit layer is warp knit, and the one or more connection yarns comprise shogged yarn portions extending between loops of adjacent courses.

Clause 21. An article of apparel comprising: a knit spacer textile comprising: a first knit layer formed from a first plurality of yarns; a second knit layer formed from a second plurality of yarns; a plurality of tie yarns that interconnect the first knit layer and the second knit layer; a first flow-through aperture extending from a first opening in the first knit layer to a second opening in the second knit layer; and a first crater formed in the second knit layer, the first crater superior to and axially aligned with the second opening in a machine-direction; wherein: a plurality of bands are knit with wales extending in a machine direction, the plurality of bands comprises a first band and a second band; the first band is disconnected from the second band along a perimeter edge of the second opening from a second opening inferior end to a second opening superior end, the first band having a first curvature between the second opening inferior end to the second opening superior end; the first band is disconnected from the second band along a perimeter edge of the first crater from a first crater inferior end to a first crater superior end, the first band having a second curvature between the first crater inferior end to the first crater superior end; and the first curvature is greater than the second curvature.

Clause 22. The article of apparel of clause 21, comprising: a second crater formed in the second knit layer, the second crater superior to the first crater and axially aligned with the second opening in the machine-direction; and a second flow-through aperture extending from a third opening in the first knit layer to a fourth opening in the second knit layer, wherein: the first band is disconnected from the second band along a perimeter edge of the second crater from a second crater inferior end to a second crater superior end, the first band having a third curvature between the second crater inferior end to the second crater superior end; the second flow-through aperture is superior to the second crater and axially aligned in the machine direction with the first flow-through aperture, the first band is disconnected from the second band along a perimeter edge of the fourth opening from a fourth opening inferior end to a fourth opening superior end, first band having a fourth curvature between the second opening inferior end to the second opening superior end; the third curvature is less than the first curvature; and the fourth curvature is greater than the second curvature and the third curvature.

Clause 23. The article of apparel of clause 22, wherein the fourth curvature is equal to the first curvature and the third curvature is equal to the second curvature.

Clause 24. An article of apparel comprising: a knit spacer textile comprising: a first knit layer formed from a first plurality of yarns; a second knit layer formed from a second plurality of yarns; a plurality of tie yarns that interconnect the first knit layer and the second knit layer; a first flow-through aperture extending from a first opening in the first knit layer to a second opening in the second knit layer, a second flow-through aperture extending from a third opening in the first knit layer to a fourth opening in the second knit layer; a first crater formed in the second knit layer; a second crater formed in the second knit layer; wherein: each of the second opening, the fourth opening, the first crater, and the second crater axially aligned in a machine-direction, the first crater and the second crater positioned between the second opening and the fourth opening; a plurality of bands are knit with wales extending in a machine direction, the plurality of bands comprises a first band and a second band; the first band is disconnected from the second band along a perimeter edge of the second opening, the first crater, the second crater and the fourth opening; and the first band has five inflections between the second opening and the fourth opening.

Clause 25. The article of apparel of clause 24, wherein: the first band is convex relative to the second band at three segments between the second opening and the fourth opening; and the first band is concave relative to the second band at two segments between the second opening and the fourth opening.

Clause 26. The article of apparel of any of clauses 24 to 25, wherein the first knit layer and the second knit layer comprise one of polyester, drawn textured yarn, nylon, chemically recycled polyester, mechanically recycled polyester, and a cationic dyeable yarn.

Clause 27. The article of apparel of any of clauses 24 to 26, wherein the knit spacer textile has a thickness between 1.5mm and 2.0 mm.

Clause 28. The article of apparel of any of clauses 24 to 27, wherein the second knit layer has an openness between about 15% to 20%.

Clause 29. The article of apparel of any of clauses 24 to 28, wherein each of the bands comprise an equal number of wales.

Clause 30. The article of apparel of any of clauses 24 to 29, wherein each of the bands has between 4 and 8 wales.

Clause 31. An article of apparel comprising: a knit spacer textile comprising an outer knit layer with an outer surface, an inner knit layer with an inner surface, and a plurality of tie yarns connecting the outer knit layer with the inner knit layer, the knit spacer textile having a thickness between the outer surface and the inner surface; a plurality of flow-through apertures extending through an entirety of the thickness, each of the flow-through apertures having an inner layer opening in the inner surface; and a plurality of cavities extending from the inner surface partially into the thickness.

Clause 32. The article of apparel of clause 31, wherein the inner layer openings of the plurality of flow-through apertures are arranged in a series of rows, each row extending in a first direction.

Clause 33. The article of apparel of clause 32, wherein adjacent inner layer openings within each row are evenly spaced from each other in the first direction.

Clause 34. The article of apparel of clause 33, wherein the inner layer openings in adjacent rows are offset from each other in the first direction and a second direction perpendicular to the first direction.

Clause 35. The article of apparel of clause 33, wherein adjacent rows of inner layer openings are separated by one or more rows of cavities, each row of cavities extending in the first direction parallel to the rows of inner layer openings.

Clause 36. The article of apparel of clause 35, wherein two rows of cavities are positioned between adjacent rows of flow-through apertures.

Clause 37. The article of apparel of clause 35, wherein the two rows of cavities comprise a first row and a second row, and the cavities in the first row are offset in the first direction and a second direction perpendicular to the first direction from the cavities in the second row.

Clause 38. The article of apparel of any of clauses 31 to 37, wherein each of the cavities extends to an inward surface of the outer knit layer.

Clause 39. The article of apparel of clause 38, wherein each of the cavities comprises a volume defined by a perimeter of a cavity inner layer opening in the inner layer, the inner surface of the outer knit layer, and a plurality of tie-in yarns adjacent the perimeter.

Clause 40. The article of apparel of clause 39, wherein the perimeter is generally oval in shape.

Clause 41. The article of apparel of any of clauses 31 to 40, wherein each flow-through aperture further comprises an outer layer opening with a first surface area that is larger than a second surface area of the inner layer opening.

Clause 42. The article of apparel of clause 41, wherein the outer layer opening is a first shape and the inner layer opening is a second shape that is different than the first shape.

Clause 43. The article of apparel of clause 42, wherein the cavity comprises a cavity opening shape that is different than the first shape and the second shape.

Clause 44. The article of apparel of any of clauses 41 to 44, wherein the plurality of ties yarns comprises a first set of tie yarns that extend from the outer knit layer to the inner knit layer and are not adjacent to any of a perimeter edge of the inner layer opening, a perimeter edge of any of the cavities, and a perimeter edge of an outer layer opening of the flow-through apertures.

Clause 45. An article of apparel comprising: a knit spacer textile comprising: a first knit layer formed from a first plurality of yarns; a second knit layer formed from a second plurality of yarns; a plurality of tie yarns that interconnect the first knit layer and the second knit layer; a plurality of flow-through apertures formed in the knit spacer textile, each flow-through aperture extending from a respective first opening in the first knit layer to a respective second opening in the second knit layer; and a plurality of craters formed in the knit spacer textile, each of the craters extending from a respective third opening in the second knit layer partially through the knit spacer textile.

Clause 46. The article of apparel of clause 45, wherein the knit spacer textile is warp knit.

Clause 47. The article of apparel of any of clauses 45 to 46, wherein the plurality of flow-through apertures and the plurality of craters are each integrally formed in the knit spacer textile.

Clause 48. The article of apparel of any of clauses 45 to 47, wherein an opening area of the respective third opening is less than an opening area of the respective second opening.

Clause 49. The article of apparel of clause 48, wherein the opening area of the respective second opening is less than an opening area of the respective first opening.

Clause 50. The article of apparel of any of clauses 45 to 49, wherein a perimeter length of the respective third opening is less than a perimeter length of the respective second opening.

Clause 51. The article of apparel of clause 50, wherein the perimeter length of the respective second opening is less than a perimeter length of the respective first opening.

Clause 52. An article of apparel comprising: a knit spacer textile comprising: a first knit layer formed from a first plurality of yarns; a second knit layer formed from a second plurality of yarns; and a plurality of tie yarns that interconnect the first knit layer and the second knit layer, wherein: the knit spacer textile has a first zone, a second zone and a third zone; the first zone comprises the first knit layer, the second knit layer and the plurality of tie yarns that extend through the textile from the first knit layer, the plurality of tie yarns, and the second knit layer, the first zone having a first basis weight, the second zone comprises the second knit layer and the plurality of tie yarns, the second zone having a second basis weight, and the third zone comprises the first knit layer and the plurality of tie yarns, the third zone having a third basis weight, wherein the first basis weight is greater than both of the second basis weight and the third basis weight.

Clause 53. The article of apparel of clause 52, wherein the second zone includes a perimeter edge of an opening in the first knit layer, a second perimeter edge of a second opening in the second knit layer, and a beveled surface that extends between the first perimeter edge and the second perimeter edge, the beveled surface having a variable thickness between the first perimeter and the second perimeter edge.

Clause 54. The article of apparel of clause 53, wherein the second basis weight is variable and decreases from the first perimeter edge to the second perimeter edge.

Clause 55. The article of apparel of any of clauses 52 to 54, wherein the third zone includes a third perimeter edge of a third opening in the second knit layer and a cavity wall extending from the third perimeter edge and defining a cavity formed in the knit spacer textile, the cavity having a variable depth from the third perimeter to a central location within a thickness of the first knit layer.

Clause 56. The article of apparel of clause 55, wherein the third basis weight is variable and decreases from the third perimeter edge to the central location.

Clause 57. The article of apparel of any of clauses 52 to 56, wherein the second basis weight is less than the third basis weight.

Clause 58. The article of apparel of any of clauses 52 to 57, wherein the third basis weight is less than the second basis weight.

Clause 59. The article of apparel of any of clauses 52 to 58, wherein the second zone comprises a flow-through aperture.

Clause 60. The article of apparel of any of clauses 52 to 59, wherein the third zone comprises a cavity.

Clause 61. An article of apparel comprising: a knit textile comprising: a first knit layer formed from a first plurality of yarns, the first knit layer comprising a plurality of first openings; a second knit layer formed from a second plurality of yarns, the second knit layer comprising: a plurality of second openings, each of the second openings axially aligned with a corresponding first opening to form a flow-through aperture; a plurality of third openings; and a plurality of tie yarns that interconnect the first knit layer and the second knit layer; wherein a thickness of the knit textile at the plurality of third openings is different from a thickness of the knit textile in a portion that comprises the first knit layer, the second knit layer, and the plurality of tie yarns.

Clause 62. An article of apparel comprising: a knit spacer textile comprising: a first knit layer formed from a first plurality of yarns, the first knit layer comprising a set of first openings; and a second knit layer formed from a second plurality of yarns, the second knit layer comprising: a set of second openings, each of the second openings axially aligned with a corresponding first opening to form a flow-through aperture, a set of third openings, wherein each third opening is offset from each of the first openings; and a plurality of tie yarns that interconnect the first knit layer and the second knit layer.

Clause 63. The article of apparel of clause 62, wherein each of the first openings comprises a first opening area and each of the second openings comprises a second opening area that is different than the first opening area.

Clause 64. The article of apparel of clause 63, wherein the first opening area is greater than the second opening area.

Clause 65. The article of apparel of clause 64, wherein each of the third openings comprise a third opening area that is different than the first opening area and the second opening area.

Clause 66. The article of apparel of clause 65, wherein the third opening area is less than the second opening area.

Clause 67. The article of apparel of any of clauses 62 to 66, wherein the second knit layer comprises a machine direction and a cross direction, and the set of second openings are arranged in a plurality of rows aligned in the cross direction.

Clause 68. The article of apparel of clause 67, wherein each of the third openings is offset from a nearest adjacent second opening in both the machine direction and the cross direction.

Clause 69. The article of apparel of any of clauses 62 to 68 wherein the first knit layer, and the plurality of tie yarns define a cavity for each of the third openings.

Clause 70. The article of apparel of clause 69, wherein the cavity is elliptical wedge shaped.

Clause 71. The article of apparel of clause 69 wherein the cavity is dome shaped.

Clause 72. The article of apparel of any of clauses 62 to 71, wherein the first knit layer comprises a first periodic tiling comprising a first pattern and the second knit layer comprises a corresponding second periodic tiling comprising a second pattern.

Clause 73. The article of apparel of clause 72, wherein a first area of a first knit layer surface for the first pattern is different from a second area of a second knit layer surface for the second pattern.

Clause 74. The article of apparel of clause 72, wherein the first pattern comprises one first opening and the second pattern comprises one second opening and two third openings.

Clause 75. The article of apparel of any of clauses 62 to 74, wherein the knit spacer textile has a basis weight of between 150 and 250 g/m2.

Clause 76. The article of apparel of any of clauses 62 to 75, wherein the knit spacer textile comprises a thickness between a first outer surface of the first knit layer and a second outer surface of the second knit layer of between about 1.5mm and about 2.0 mm.

Clause 77. The article of apparel of any of clauses 62 to 76, wherein the knit spacer textile has a stiffness of between 0.09 to 0.14 kgF.

Clause 78. An article of apparel comprising: a knit spacer textile comprising: a first knit layer formed from a first plurality of yarns; a second knit layer formed from a second plurality of yarns; a plurality of tie yarns that interconnect the first knit layer and the second knit layer; a first flow-through aperture extending from a first opening in the first knit layer to a second opening in the second knit layer, a second flow-through aperture extending from a third opening in the first knit layer to a fourth opening in the second knit layer; a third flow-through aperture extending from a fifth opening in the first knit layer to a sixth opening in the second knit layer; and a first crater, a second crater, a third crater, a fourth crater, a fifth crater, and a sixth crater each formed in the second knit layer; wherein: the first crater, the second crater, and the third crater are each superior to the second opening; the fourth crater, the fifth crater, and the sixth crater are each inferior to the second opening; and the fourth opening and the sixth opening are each adjacent and offset in opposite directions from the second opening along a cross-direction axis.

Clause 79. The article of apparel of clause 78, wherein the second opening, the fourth opening and the sixth opening are axially aligned in a cross-direction.

Clause 80. The article of apparel of clause 79, wherein the first crater and the fourth crater are between the second opening and the fourth opening in the cross-direction, the third crater and the sixth crater are between the second opening and the sixth opening in the cross-direction, and the second crater and the fifth crater are axially aligned with the second opening in a machine-direction.

Clause 81. The article of apparel of clause 78, wherein the second knit layer comprises a skin-facing side of a portion of the article of apparel.

Clause 82: the knit spacer textile of any of clauses 14 to 20, wherein the knit spacer textile forms at least a portion of an article of apparel.

Clause 83. The article of apparel of any of clauses 1 to 13 and 21-82, wherein the article of apparel is an upper-body garment.

Clause 84. The article of apparel of any of clauses 1 to 13 and 21-82, wherein the article of apparel is a lower-body garment.

Clause 85. The article of apparel of any of clauses 1 to 13 and 21-82, wherein the article of apparel is an article of headwear.

Clause 86. The article of apparel of any of clauses 1 to 13 and 21-82, wherein the article of apparel is a hat.

Clause 87. The article of apparel of any of clauses 1 to 13 and 21-82, wherein the article of apparel is an article of footwear.

Clause 88. The article of apparel of any of clauses 1 to 13 and 21-82, wherein the article of apparel is an upper of a shoe or a sock liner.

Clause 89. The article of apparel of any of clauses 1 to 13 and 21-82, wherein the article of apparel is a sleeve.

Clause 90. The article of apparel of any of clauses 1 to 13 and 21-82, wherein the knit spacer textile has a dry air permeability of greater than about 300 cfm.

Aspects of the present disclosure have been described with the intent to be illustrative rather than restrictive. Alternative aspects will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. An article of apparel comprising:
a knit spacer textile comprising an outer knit layer with an outer surface, an inner knit layer with an inner surface, and a plurality of tie yarns connecting the outer knit layer with the inner knit layer, the knit spacer textile having a thickness between the outer surface and the inner surface;
a plurality of flow-through apertures extending through an entirety of the thickness, each of the flow-through apertures having an inner layer opening in the inner surface; and
a plurality of cavities extending from the inner surface partially into the thickness.

2. The article of apparel of claim 1, wherein the inner layer openings of the plurality of flow-through apertures are arranged in a series of rows, each row extending in a first direction.

3. The article of apparel of claim 2, wherein adjacent inner layer openings within each row are evenly spaced from each other in the first direction.

4. The article of apparel of claim 3, wherein the inner layer openings in adjacent rows are offset from each other in the first direction and a second direction perpendicular to the first direction.

5. The article of apparel of claim 3, wherein adjacent rows of inner layer openings are separated by one or more rows of cavities, each row of cavities extending in the first direction parallel to the rows of inner layer openings.

6. The article of apparel of claim 5, wherein two rows of cavities are positioned between adjacent rows of flow-through apertures.

7. The article of apparel of claim 5, wherein the two rows of cavities comprise a first row and a second row, and the cavities in the first row are offset in the first direction and a second direction perpendicular to the first direction from the cavities in the second row.

8. The article of apparel of claim 1, wherein each of the cavities extends to an inward surface of the outer knit layer.

9. The article of apparel of claim 8, wherein each of the cavities comprises a volume defined by a perimeter of a cavity inner layer opening in the inner layer, the inner surface of the outer knit layer, and a plurality of tie-in yarns adjacent the perimeter.

10. The article of apparel of claim 9, wherein the perimeter is generally oval in shape.

11. The article of apparel of claim 1, wherein each flow-through aperture further comprises an outer layer opening with a first surface area that is larger than a second surface area of the inner layer opening.

12. The article of apparel of claim 11, wherein the outer layer opening is a first shape and the inner layer opening is a second shape that is different than the first shape.

13. The article of apparel of claim 12, wherein the cavity comprises a cavity opening shape that is different than the first shape and the second shape.

14. The article of apparel of claim 1, wherein the plurality of ties yarns comprises a first set of tie yarns that extend from the outer knit layer to the inner knit layer and are not adjacent to any of a perimeter edge of the inner layer opening, a perimeter edge of any of the cavities, and a perimeter edge of an outer layer opening of the flow-through apertures.

15. An article of apparel comprising:
a knit spacer textile comprising:
a first knit layer formed from a first plurality of yarns;
a second knit layer formed from a second plurality of yarns;
a plurality of tie yarns that interconnect the first knit layer and the second knit layer;
a plurality of flow-through apertures formed in the knit spacer textile, each flow-through aperture extending from a respective first opening in the first knit layer to a respective second opening in the second knit layer; and
a plurality of craters formed in the knit spacer textile, each of the craters extending from a respective third opening in the second knit layer partially through the knit spacer textile.

16. The article of apparel of claim 15, wherein the knit spacer textile is warp knit.

17. The article of apparel of claim 15, wherein the plurality of flow-through apertures and the plurality of craters are each integrally formed in the knit spacer textile.

18. The article of apparel of claim 15, wherein an opening area of the respective third opening is less than an opening area of the respective second opening.

19. The article of apparel of claim 18, wherein the opening area of the respective second opening is less than an opening area of the respective first opening.

20. The article of apparel of claim 15, wherein a perimeter length of the respective third opening is less than a perimeter length of the respective second opening.

21. The article of apparel of claim 20, wherein the perimeter length of the respective second opening is less than a perimeter length of the respective first opening.

22. An article of apparel comprising:
a knit spacer textile comprising:
a first knit layer formed from a first plurality of yarns;
a second knit layer formed from a second plurality of yarns; and
a plurality of tie yarns that interconnect the first knit layer and the second knit layer,
wherein:
the knit spacer textile has a first zone, a second zone and a third zone;
the first zone comprises the first knit layer, the second knit layer and the plurality of tie yarns that extend through the textile from the first knit layer, the plurality of tie yarns, and the second knit layer, the first zone having a first basis weight,
the second zone comprises the second knit layer and the plurality of tie yarns, the second zone having a second basis weight, and
the third zone comprises the first knit layer and the plurality of tie yarns, the third zone having a third basis weight,
wherein the first basis weight is greater than both of the second basis weight and the third basis weight.

23. The article of apparel of claim 22, wherein the second zone includes a perimeter edge of an opening in the first knit layer, a second perimeter edge of a second opening in the second knit layer, and a beveled surface that extends between the first perimeter edge and the second perimeter edge, the beveled surface having a variable thickness between the first perimeter and the second perimeter edge.

24. The article of apparel of claim 23, wherein the second basis weight is variable and decreases from the first perimeter edge to the second perimeter edge.

25. The article of apparel of claim 22, wherein the third zone includes a third perimeter edge of a third opening in the second knit layer and a cavity wall extending from the third perimeter edge and defining a cavity formed in the knit spacer textile, the cavity having a variable depth from the third perimeter to a central location within a thickness of the first knit layer.

26. The article of apparel of claim 25, wherein the third basis weight is variable and decreases from the third perimeter edge to the central location.

27. The article of apparel of claim 22, wherein the second basis weight is less than the third basis weight.

28. The article of apparel of claim 22, wherein the third basis weight is less than the second basis weight.

29. The article of apparel of claim 22, wherein the second zone comprises a flow-through aperture.

30. The article of apparel of claim 22, wherein the third zone comprises a cavity.

31. An article of apparel comprising:
a knit textile comprising:
a first knit layer formed from a first plurality of yarns, the first knit layer comprising a plurality of first openings;
a second knit layer formed from a second plurality of yarns, the second knit layer comprising:
a plurality of second openings, each of the second openings axially aligned with a corresponding first opening to form a flow-through aperture;
a plurality of third openings; and
a plurality of tie yarns that interconnect the first knit layer and the second knit layer;
wherein a thickness of the knit textile at the plurality of third openings is different from a thickness of the knit textile in a portion that comprises the first knit layer, the second knit layer, and the plurality of tie yarns.
